(19) United States
(12) Patent Application Publication
(10) Pub. No.: US 2026/0228994 A1
(43) Pub. Date: Aug. 6, 2026

(54) INFORMATION PROCESSING SYSTEM, IMAGE MANAGEMENT SERVER, AND NON-TRANSITORY RECORDING MEDIUM

(71) Applicant: Naoki MOTOHASHI, Kanagawa (JP)

(72) Inventor: Naoki MOTOHASHI, Kanagawa (JP)

(21) Appl. No.: 19/454,404

(22) Filed: Jan. 21, 2026

(30) Foreign Application Priority Data
Feb. 6, 2025 (JP) 2025-018414

(51) Int. Cl. G06T 19/20; G06V 10/774; G06V 10/82; G09B 7/02; G10L 15/26; G10L 15/30

(52) U.S. Cl. CPC G06T 19/20; G10L 15/26; G06T 2219/2004; G06V 10/7753; G06V 10/82; G09B 7/02; G10L 15/30

(57) ABSTRACT

An information processing system includes an image management server that manages three-dimensional image information of a target object and a captured image, including server cirucuitry to generate text information related to the target object using a first model or a second model; and a terminal device to display a screen including the text information. The first model is trained on a correspondence between the three-dimensional image information and speech text based on audio data obtained with the captured image, or a correspondence between the three-dimensional image information, the speech text, and input information. The second model is trained on a correspondence between the three-dimensional image information and the input information. The server circuitry generates the text information using selected three-dimensional image information, the speech text, and the first model, or generates the text information using the selected three-dimensional image information and the second model.

### CROSS-REFERENCE TO RELATED APPLICATION

This patent application is based on and claims priority pursuant to 35 U.S.C. § 119(a) to Japanese Patent Application No. 2025-018414, filed on Feb. 6, 2025, in the Japan Patent Office, the entire disclosure of which is hereby incorporated by reference herein.

### BACKGROUND

### Technical Field

The present disclosure relates to an information processing system, an image management server, and a non-transitory recording medium.

### Related Art

Generative artificial intelligence (AI) allows generation of text information from various kinds of content (e.g., text, images, and voices). Conventional AI presents the best answer based on data on which the AI has been trained. In contrast, generative AI, which continuously learns by itself, learns even from information or data not provided by humans and can output original content that has not been input.

There is a technique for improving the quality of training data in machine learning. For example, a technique is disclosed in which a learning model outputs a failure recovery procedure using failure information received from a user as input and sets a weight of evaluation regarding usefulness of the failure recovery procedure used by the learning model for retraining, based on skill information indicating the skill of the user in failure recovery.

### SUMMARY

The present disclosure described herein provides an information processing system including an image management server that manages three-dimensional image information of a target object and a captured image aligned in position with the three-dimensional image information, the image management server including server cirucuitry to generate text information related to the target object using a first model or a second model; and a terminal device communicably connected to the image management server, including terminal circuitry to display, on a display, a screen including the text information. The first model is trained on a correspondence between the three-dimensional image information of the target object and speech text based on audio data obtained with the captured image of an image capturing device, or a correspondence between the three-dimensional image information of the target object, the speech text, and input information input to the terminal device. The second model is trained on a correspondence between the three-dimensional image information of the target object and the input information input to the terminal device. When the first model is used, the server circuitry is configured to generate the text information related to the target object using selected three-dimensional image information of the target object having been selected by the terminal device, the speech text, and the first model. When the second model is used, the server circuitry is configured to generate the text information using the selected three-dimensional image information, and the second model.

The present disclosure described herein provides an image management server communicably connectable to a terminal device, including server circuitry to generate text information related to a target object using a first model or a second model, and transmit a screen including the text information to the terminal device to display the screen on the terminal device. The first model is trained on a correspondence between three-dimensional image information of the target object and speech text based on audio data obtained with a captured image of an image capturing device, the captured image to be aligned in position with the three-dimensional image information, or a correspondence between the three-dimensional image information of the target object, the speech text, and input information input to the terminal device. The second model is trained on a correspondence between the three-dimensional image information of the target object and the input information input to the terminal device. When the first model is used, the server circuitry is configured to generate the text information related to the target object using selected three-dimensional image information of the target object having been selected by the terminal device, the speech text, and the first model. When the second model is used, the server circuitry is configured to generate the text information using the selected three-dimensional image information, and the second model.

The present disclosure described herein provides a non-transitory recording medium storing a plurality of instructions which, when executed by one or more processors, causes the one or more processors to perform a method including generating text information related to a target object using a first model or a second model; and displaying, on a display, a screen including the text information. The first model is trained on a correspondence between three-dimensional image information of the target object and speech text based on audio data obtained with a captured image of an image capturing device, the captured image to be aligned in position with the three-dimensional image information, or a correspondence between the three-dimensional image information of the target object, the speech text, and input information input to a terminal device. The second model is trained on a correspondence between the three-dimensional image information of the target object and the input information input to the terminal device. When the first model is used, the generating includes generating the text information related to the target object using selected three-dimensional image information of the target object having been selected by the terminal device, the speech text, and the first model. When the second model is used, the generating includes generating the text information using the selected three-dimensional image information, and the second model.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of an example of an information processing system;

FIG. 2 is a diagram illustrating a hardware configuration of an example of an image management server, a conference management server, and a terminal device;

FIG. 3 is a diagram illustrating a functional configuration of an example of functions of the image management server, the conference management server, and the terminal device in the information processing system illustrated in FIG. 1;

FIG. 4 is an illustration of an example of a three-dimensional image information management table;

FIG. 5 is an illustration of an example of a captured image information management table;

FIG. 6 is an illustration of an example of a conference information management table;

FIG. 7 is a sequence diagram illustrating an example of a process of communicating a wide-view image and audio data;

FIGS. 8A and 8B are diagrams illustrating an example of screens displayed on the terminal device in a model update process and a text information generation process, respectively;

FIGS. 9A and 9B are diagrams illustrating an example of screens displayed on the terminal device in the model update process and the text information generation process, respectively;

FIG. 10 is a sequence diagram illustrating an example of a process of generating screen information of a screen on which speech text and a capture-generated image or three-dimensional image information are arranged, as a process based on the speech text and the capture-generated image or the three-dimensional image information;

FIGS. 11A and 11B are flowcharts illustrating examples of a process in which a determination unit determines whether to update a first tacit knowledge model or a second tacit knowledge model;

FIG. 12 is a diagram illustrating an example of a property designation screen;

FIG. 13 is a diagram illustrating an example of a speech text display screen;

FIG. 14 is a diagram illustrating an example of a text image display screen;

FIG. 15 is a diagram illustrating an example of a message displayed in a pop-up window on the text image display screen illustrated in FIG. 14;

FIGS. 16A and 16B (FIG. 16) is a sequence diagram illustrating an example of a text information generation process using the first tacit knowledge model;

FIG. 17 is a diagram illustrating an example of a text image display screen in an inference phase;

FIG. 18 is a diagram illustrating an example of a message displayed in a pop-up window on the text image display screen illustrated in FIG. 17;

FIG. 19 is a diagram illustrating an example of text information displayed on a past-text past-capture display screen;

FIGS. 20A and 20B (FIG. 20) is a sequence diagram illustrating an example of a process in which the image management server updates a model through communication with the conference management server;

FIG. 21 is a sequence diagram illustrating an example of the model update process;

FIGS. 22A and 22B (FIG. 22) is a sequence diagram illustrating an example of a text information generation process using the second tacit knowledge model;

FIG. 23 is a diagram illustrating an example of a past-text past-capture display screen including text information generated based on the second tacit knowledge model;

FIG. 24 is a sequence diagram illustrating an example of the model update process;

FIG. 25 is a flowchart illustrating an example of a process in which the determination unit determines whether to update the first tacit knowledge model or the second tacit knowledge model;

FIG. 26 is a diagram illustrating an example of a property display screen;

FIG. 27 is a sequence diagram illustrating an example of a text information generation process using the second tacit knowledge model when the terminal device directly logs in to the image management server;

FIG. 28 is a diagram illustrating an example of a property display screen when the terminal device directly logs in to the image management server;

FIG. 29 is a diagram illustrating an example of the past-text past-capture display screen;

FIG. 30 is a diagram illustrating a general arrangement of an example of an information processing system;

FIG. 31 is a diagram illustrating a functional configuration of an example of functions of the image management server, the conference management server, and the terminal device in the information processing system illustrated in FIG. 30;

FIGS. 32A and 32B (FIG. 32) is a sequence diagram illustrating an example of a process of generating text information and image information; and

FIG. 33 is a diagram illustrating an example of generated image information displayed on the past-text past-capture display screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system according to an embodiment of the present disclosure will be described hereinafter with reference to the drawings.

### Supplementary Information Related to Tacit Knowledge

In the fields of civil engineering and architecture, the implementation of building information modeling (BIM)/construction information modeling (CIM) has been promoted for, for example, coping with the demographic shift towards an older population and enhancing labor efficiency and productivity.

BIM is a solution that involves utilizing a database of buildings, in which attribute data such as cost, finishing details, and management information is added to a three-dimensional (3D) digital model of a building. This model is created on a computer and utilized throughout every stage of the architectural process, including design, construction, and maintenance. The three-dimensional digital model is referred to as a 3D model in the following description.

CIM is a solution that has been proposed for the field of civil engineering (covering general infrastructure such as roads, electricity, gas, and water supply) following BIM, which has been advancing in the field of architecture. Similar to BIM, CIM is an approach aimed at improving the efficiency and sophistication of a series of construction production systems by sharing information through a 3D model among the parties involved.

A challenge in promoting the implementation of BIM and CIM is how to utilize the constructed BIM and CIM.

Specifically, a 3D model restored by BIM and CIM can be utilized for design and construction purposes and other work such as maintenance and site inspection. That is, BIM and CIM may be used for purposes other than blueprints, such as making a record in the 3D model or sharing the record with another person.

Since work performed on the 3D model is recordable as a log, tacit knowledge extractable based on the work will be effectively used to transfer technology from experts to beginners. This is expected to contribute to front-loaded business operations, as well as personnel development and other activities.

Focusing on the transfer of tacit knowledge, a challenge is how to transfer tacit knowledge between different tasks or between users with different levels of skill, as described above, for two-dimensional (2D) datasets (such as spherical images or planar images) as well as for 3D models.

Specifically, tacit knowledge is qualitative and difficult to quantify. Even when a tacit knowledge model is generated from tacit knowledge, it is difficult to secure confidence from a user about the tacit knowledge model and to promote the use of the tacit knowledge model. For example, if the field of expertise of the user differs from the field of expertise of the tacit knowledge model, the tacit knowledge model has no practical value for the user, no matter how excellent the tacit knowledge model is. Similarly, if the knowledge level of the tacit knowledge model is lower than the knowledge level of the user, the tacit knowledge model also lacks value for the user.

However, it is a fact that the tacit knowledge model provides the user with a new point of view or awareness, and the use of the tacit knowledge model allows even an inexperienced user to acquire know-how or technology and use the know-how or technology for work.

In addition, it is desirable that a system including a terminal device and a first server that stores speech text obtained during a conference regarding a property further has a function of displaying at least one of three-dimensional image information such as a 3D model corresponding to the property and a capture-generated image that is captured during the conference.

Accordingly, in one or more embodiments of the present disclosure, processing based on speech text that is managed by a first server and at least one of three-dimensional image information and a capture-generated image that are managed by a second server is performed by the second server. This processing includes processing of displaying, on a single screen, the speech text managed by the first server and at least one of the three-dimensional image information and the capture-generated image managed by the second server.

Further, the second server can cause the terminal device to display two items of information and also display tacit knowledge related to a property, such as text information, which is generated based on at least one of the capture-generated image and the three-dimensional image information, in association with the three-dimensional image information or the capture-generated image. Accordingly, the terminal device can display the speech text and at least one of the three-dimensional image information and the capture-generated image on a single screen in association with each other or display the tacit knowledge related to the property in association with at least one of the three-dimensional image information and the capture-generated image without large addition of functions to the first server.

### Terminology

The term “user” refers to a person who uses text information generated by a tacit knowledge model. As the text information, content other than text, such as images, may be output. The term “data provider” refers to a person who provides data to be used by a tacit knowledge model for training, such as voice information, character information, operation information, images, and 3D data.

Tacit knowledge (or implicit knowledge) is knowledge that is based on personal experience, intuition, and the like. The term “tacit knowledge model” refers to a model that learns tacit knowledge and outputs an answer to a question based on the learned tacit knowledge. The term “model” refers to a mechanism or artificial intelligence (AI) that learns correspondences between input data and output data and outputs output data for input data. The output data may or may not be labeled data.

The term “property” refers to any space in which articles can be placed, such as a facility or a room in a facility. The term “article” refers to an object placed in a property. Articles to be placed vary depending on the functions of the facility.

Examples of properties include real estate, factories, construction sites, research facilities, medical facilities, agricultural land, warehouses, and equipment involving maintenance. Examples of articles include furniture, construction materials, equipment, heavy machinery, tools, instruments, materials, cultures, and foods.

The term “target object” refers to an object whose image is to be captured with an image capturing device. Specific examples of a target object include an object whose states can be managed by keeping records in the form of images. In embodiments disclosed herein, a target object is described using the term “article”. A target object is placed in a property, for example.

Three-dimensional image information of an article is an image obtained by capturing an image of a 3D model with a virtual camera. A user can change the point of view of the three-dimensional image information.

The term “generated information” refers to information generated based on three-dimensional image information and a capture-generated image. The generated information may be generated by a tacit knowledge model. In embodiments disclosed herein, generated information is described using the term “tacit knowledge comment” or “text information”.

The term “display screen” refers to a screen on which, for example, one or more of three-dimensional image information, a capture-generated image, and generated information are displayed at a time.

The term “wide-view image” refers to an image representing an imaging range including even an area that is difficult for a normal angle of view to cover. A wide-view image is an image having a wide viewing angle and captured in a wide imaging range. Such an image includes a 360-degree image that is a captured image of an entire 360-degree view. The 360-degree image is also referred to as a spherical image, an omnidirectional image, or an “all-around” image.

The term “predetermined-area image” refers to an image corresponding to a predetermined area that is a portion of a wide-view image. A predetermined-area image is projected onto a two-dimensional plane and is a planar image. In embodiments disclosed herein, a predetermined-area image is referred to as a capture-generated image since the predetermined-area image is stored by a capture operation.

### First Embodiment

### Example of System Configuration

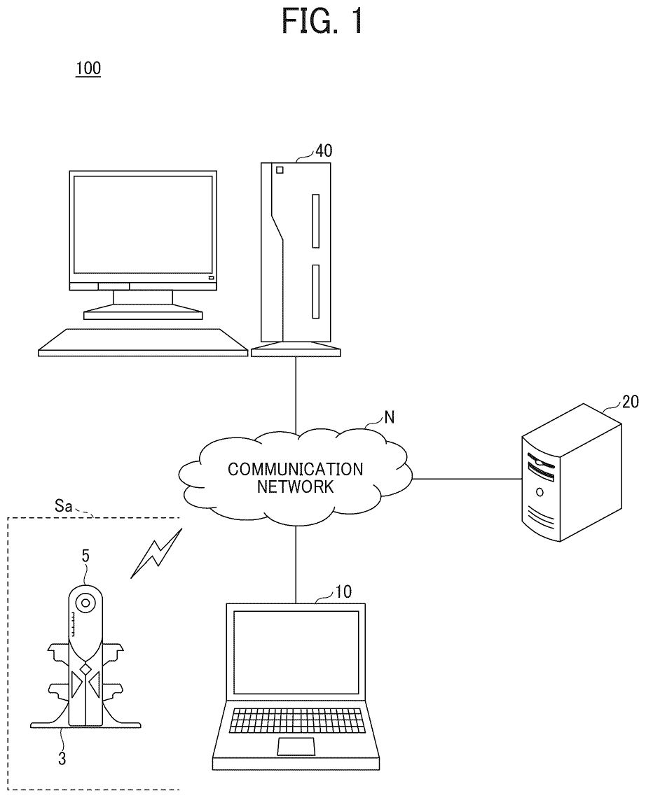

FIG. 1 is a diagram illustrating a general arrangement of an information processing system 100. The information processing system 100 includes a terminal device 10, which is an example of an input/output device, an image capturing device 5, an image management server 40, and a conference management server 20. The terminal device 10 may be external to the information processing system 100 as long as the terminal device 10 can be connected to the image management server 40 or the conference management server 20 as appropriate.

The image management server 40 (an example of a second server) includes one or more information processing apparatuses that can communicate with the terminal device 10 via a communication network N. The image management server 40 manages three-dimensional image information and capture-generated images of a property and includes a tacit knowledge model and a large language model. The image management server 40 uses the tacit knowledge model and the large language model to return text information including tacit knowledge to a user. The image management server 40 may be a web server that returns a processing result to the terminal device 10 in response to a request from the terminal device 10. The term “server” refers to a computer or software that implements a function for providing information or a processing result in response to a request from a client.

The image management server 40 may support cloud computing. Cloud computing is a mode of use that allows resources on a network to be used without identifying specific hardware resources. Cloud computing may be implemented in any form such as software as a service (SaaS), platform as a service (PaaS), or infrastructure as a service (IaaS). Accordingly, the image management server 40 may be housed in one or more housings or provided as one or more apparatuses. The functions of the image management server 40 may be distributed to a plurality of information processing apparatuses, or each of the plurality of information processing apparatuses may have all the functions of the image management server 40 and the information processing apparatus to be used for processing may be switched according to load balancing or the like.

Instead of including the tacit knowledge model and the large language model, the image management server 40 may call an application programming interface (API) published by an external system, and use at least one of the tacit knowledge model and the large language model.

The conference management server 20 (an example of a text management server) includes one or more information processing apparatuses that can communicate with the terminal device 10 via the communication network N. The conference management server 20 manages speech text of utterances captured during a conference regarding the property. Property management information is, for example, a character string such as text. The conference management server 20 does not store three-dimensional image information or stores three-dimensional image information, if any, that is merely a photograph or the like different from an image managed by the image management server 40. The conference management server 20 is a server that allows a user to update property management information as appropriate to manage, for example, the progress of construction of a property or the arrangement of articles.

The conference management server 20 may be a web server that returns a processing result to the terminal device 10 in response to a request from the terminal device 10. The conference management server 20 can communicate with the image management server 40 via the communication network N. The conference management server 20 may support either cloud computing or on-premises.

The image management server 40 and the conference management server 20 are preferably linked together in a way in which single sign-on can be achieved. The image management server 40 can communicate with the conference management server 20 via an API published by the conference management server 20. Alternatively, the image management server 40 and the conference management server 20 may cooperate with each other in performing business processes.

The terminal device 10 is a general-purpose information processing terminal used by a user of the information processing system 100. In the terminal device 10, a web browser or a native application dedicated to the image management server 40 or the conference management server 20 operates. In a case where the terminal device 10 executes a web browser, the terminal device 10 and the image management server 40 or the conference management server 20 execute a web application. The web application is an application that operates in cooperation with a program written in a programming language (e.g., JavaScript®) operating on a web browser and a program on the web server (e.g., the image management server 40). In a case where the web application is executed, processing according to the present embodiment may be performed by the image management server 40 or the conference management server 20, or may be performed by the terminal device 10 that has received the web application.

An application that is installed and executed locally on the terminal device 10 is referred to as a native application. Also in the present embodiment, the application executed on the terminal device 10 may be either a web application or a native application. In a case where the native application is executed, the processing according to the present embodiment may be performed by the image management server 40 or the terminal device 10 that executes the native application.

In one example, the terminal device 10 is a personal computer (PC), a smartphone, a personal digital assistant (PDA), or a tablet terminal. The terminal device 10 is any device on which a web browser or a native application operates. The terminal device 10 may be an electronic whiteboard, a television receiver, a glasses device, or a wearable device. A plurality of terminal devices 10 may be present.

The terminal device 10 can communicate with the image management server 40 and the conference management server 20 via the communication network N. The communication network N is implemented by, for example, the Internet, a local area network (LAN), or a provider service. The communication network N may include a wired communication network and a wireless LAN-based network or a mobile communication network such as a third generation (3G), Worldwide Interoperability for Microwave Access (WiMAX), or long term evolution (LTE) network. The terminal device 10 also supports communication using short-range communication technology such as Bluetooth® or near field communication (NFC®).

The image capturing device 5 is a digital camera for obtaining a wide-view image and recording audio. The image capturing device 5 is connected to the communication network N via a relay device 3. The relay device 3 has a function of a cradle for charging the image capturing device 5 and transmitting and receiving data to and from the image capturing device 5. The relay device 3 can perform data communication with the image capturing device 5 via a contact point and can also perform data communication with the conference management server 20 via the communication network N. The image capturing device 5 and the relay device 3 are placed at predetermined positions in a site Sa such as a construction site, an exhibition site, an education site, or a medical site. The image capturing device 5 may be a digital camera that obtains ordinary narrow field-of-view captured images, such as a single-lens reflex camera, and the conference management server 20 may distribute live images of narrow field-of-view captured images captured by the image capturing device 5. In a case where the image capturing device 5 obtains a narrow field-of-view captured image, the predetermined-area image is an image corresponding to a predetermined area that is all or a portion of the captured image.

In FIG. 1, the image management server 40, the conference management server 20, and the terminal device 10 communicate with one another via the communication network N. In another example, a user may directly operate the image management server 40 or the conference management server 20 from a console, or the terminal device 10 may have the functions of the image management server 40 or the conference management server 20. In other words, the terminal device 10 may provide the functions of the information processing system 100 in a stand-alone manner.

### Example of Hardware Configuration

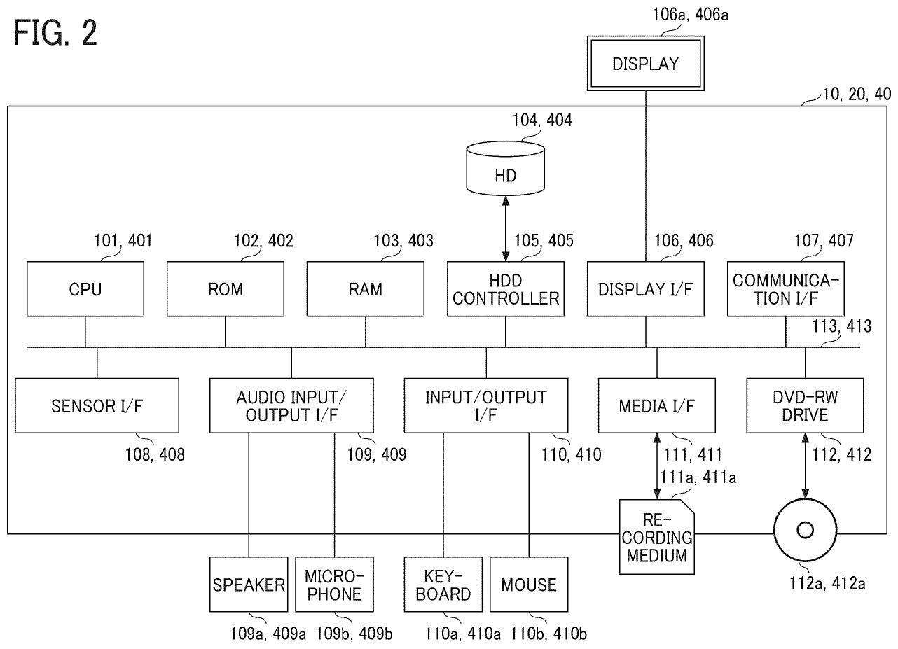

FIG. 2 is a diagram illustrating a hardware configuration of the image management server 40, the conference management server 20, and the terminal device 10. The hardware elements of the image management server 40 and the conference management server 20 are designated by reference numerals in the 400 series. The hardware elements of the terminal device 10 are designated by reference numerals in the 100 series.

The following describes the hardware elements of the terminal device 10. Since the hardware elements of the image management server 40 and the conference management server 20 are similar to those of the terminal device 10, the description thereof will be omitted.

The terminal device 10 is implemented by a computer. As illustrated in FIG. 2, the terminal device 10 includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 controls the overall operation of the terminal device 10. The ROM 102 stores a program used for booting the CPU 101, such as an initial program loader (IPL). The RAM 103 is used as a work area for the CPU 101.

The HD 104 stores various data such as a program. The HDD controller 105 controls reading or writing of various data from or to the HD 104 under the control of the CPU 101.

The display I/F 106 is a circuit that controls a display 106a to display an image. The display 106a is a type of display unit such as a liquid crystal display or an organic electroluminescent (EL) display that displays various types of information such as a cursor, a menu, a window, characters, or an image. The communication I/F 107 is an interface used for communication with another device.

When the terminal device 10 is a glasses device, the terminal device 10 may use a circuit that controls a member having transmissive and reflective properties, such as a lens, to display an image as an alternative to the display I/F 106.

The communication I/F 107 is, for example, a network interface card (NIC) in compliance with Transmission Control Protocol/Internet Protocol (TCP/IP).

The terminal device 10 further includes a sensor I/F 108, an audio input/output I/F 109, an input I/F 110, a media I/F 111, and a digital versatile disc rewritable (DVD-RW) drive 112.

The sensor I/F 108 is an interface that receives information detected by various sensors. The audio input/output I/F 109 is a circuit that processes the input of audio signals from a microphone 109b and the output of audio signals to a speaker 109a under the control of the CPU 101. The input I/F 110 is an interface for connecting predetermined input means to the terminal device 10.

A keyboard 110a is a type of input means including multiple keys for inputting, for example, characters, numerical values, or various instructions. A mouse 110b is a type of input means for selecting or executing various instructions, selecting a target for processing, moving a cursor being displayed, or performing an operation on a display screen.

The media I/F 111 controls reading or writing (storing) data from or to a recording medium 111a such as flash memory. The DVD-RW drive 112 controls reading or writing of various data from or to a DVD-RW 112a, which is an example of a removable recording medium. In place of the DVD-RW 112a, a digital versatile disc recordable (DVD-R) may be used. In place of the DVD-RW drive 112, a Blu-ray drive that controls reading or writing of various data from or to a Blu-ray Disc® may be used.

The terminal device 10 further includes a bus line 113. Examples of the bus line 113 include an address bus and a data bus. The bus line 113 electrically connects the components of the terminal device 10, such as the CPU 101, to one another.

The programs described above may be stored in recording media such as an HD and a compact disc read-only memory (CD-ROM), and the recording media may be distributed domestically or internationally as program products. For example, the terminal device 10 executes a program according to an embodiment of the present disclosure to implement an information processing method according to an embodiment of the present disclosure.

### Functions

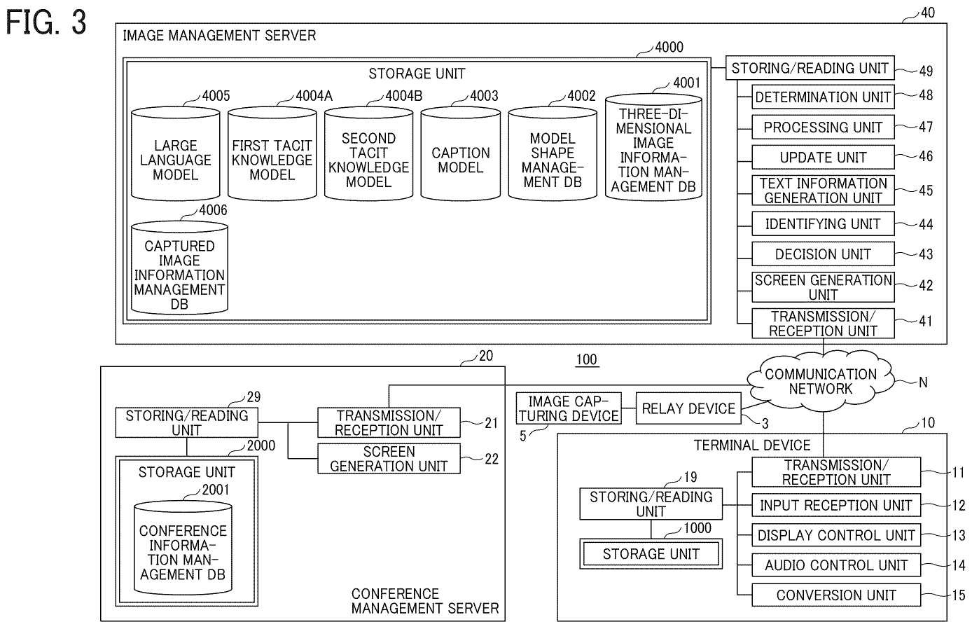

FIG. 3 is a diagram illustrating a functional configuration of functions of the image management server 40, the conference management server 20, and the terminal device 10 in the information processing system 100. The image capturing device 5 and the relay device 3 have existing functions.

### Terminal Device

As illustrated in FIG. 3, the terminal device 10 includes a transmission/reception unit 11, an input reception unit 12, a display control unit 13, an audio control unit 14, a conversion unit 15, and a storing/reading unit 19. Each of these units is a function implemented by or means caused to function by any one or more of the hardware elements illustrated in FIG. 2 operating in accordance with instructions from the CPU 101 according to a program loaded onto the RAM 103 from the HD 104. The terminal device 10 further includes a storage unit 1000, which is implemented by at least one of the RAM 103 and the HD 104 illustrated in FIG. 2.

The transmission/reception unit 11 is an example of transmission means and is implemented by instructions from the CPU 101 illustrated in FIG. 2 and by the communication I/F 107 illustrated in FIG. 2. The transmission/reception unit 11 transmits and receives various data (or information) to and from another terminal, device, apparatus, or system via the communication network N.

The input reception unit 12 is an example of input reception means and is implemented by instructions from the CPU 101 illustrated in FIG. 2 and by the input I/F 110 and the audio input/output I/F 109 illustrated in FIG. 2. The input reception unit 12 receives various inputs from the user through the microphone 109b, the keyboard 110a, and the mouse 110b.

The display control unit 13 is an example of display control means and output means and is implemented by instructions from the CPU 101 illustrated in FIG. 2 and by the display I/F 106 illustrated in FIG. 2. The display control unit 13 controls the display 106a, which is an example of a display unit, to display various images and screens. When the terminal device 10 is a glasses device, the display control unit 13 controls a member having transmissive and reflective properties, such as a lens, to display a virtual image as an alternative to the display I/F 106.

The audio control unit 14 is an example of audio control means and output means and is implemented by instructions from the CPU 101 illustrated in FIG. 2 and by the audio input/output I/F 109 illustrated in FIG. 2. The audio control unit 14 controls the speaker 109a, which is an example of an audio reproduction unit, to reproduce audio.

The conversion unit 15 is an example of processing means and is implemented by instructions from the CPU 101 illustrated in FIG. 2. The conversion unit 15 performs processing for converting character information into voice information or processing for converting voice information into character information.

The storing/reading unit 19 is an example of storage control means and is implemented by instructions from the CPU 101 illustrated in FIG. 2 and by the HD 104, the media I/F 111, and the DVD-RW drive 112 illustrated in FIG. 2. The storing/reading unit 19 stores various data in the storage unit 1000, the recording medium 111a, or the DVD-RW 112a and reads various data from the storage unit 1000, the recording medium 111a, or the DVD-RW 112a.

### Functional Configuration of Image Management Server

The image management server 40 includes a transmission/reception unit 41, a screen generation unit 42, a decision unit 43, an identifying unit 44, a text information generation unit 45, an update unit 46, a processing unit 47, a determination unit 48, and a storing/reading unit 49. Each of these units is a function implemented by or means caused to function by any one or more of the hardware elements illustrated in FIG. 2 operating in accordance with instructions from the CPU 401 according to a program loaded onto the RAM 403 from the HD 404. The image management server 40 further includes a storage unit 4000, which is implemented by the HD 404 illustrated in FIG. 2. The storage unit 4000 is an example of storage means.

In FIG. 3, the single image management server 40 has all the functions described above. The image management server 40 may be configured to implement the functions in a distributed manner across multiple computers.

The transmission/reception unit 41 is an example of a transmission unit or a reception unit and is implemented by instructions from the CPU 401 illustrated in FIG. 2 and by the communication I/F 407 illustrated in FIG. 2. The transmission/reception unit 41 transmits and receives various data (or information) to and from another terminal, device, apparatus, or system via the communication network N.

The screen generation unit 42 is an example of screen generation means and is implemented by instructions from the CPU 401 illustrated in FIG. 2. The screen generation unit 42 generates various screens. In a case where the terminal device 10 executes a web application, screen information is created by Hypertext Markup Language (HTML), Extensible Markup Language (XML), Cascading Style Sheets (CSS), JavaScript®, or the like. Thus, the screen information may be referred to as a web application. In a case where the terminal device 10 executes a client application, the screen information is stored in the terminal device 10, and the information to be displayed is transmitted in the form of, for example, XML.

The decision unit 43 is an example of determination means and is implemented by instructions from the CPU 401 illustrated in FIG. 2. The decision unit 43 performs various determinations described below.

The identifying unit 44 is an example of identifying means and is implemented by instructions from the CPU 401 illustrated in FIG. 2. The identifying unit 44 identifies a target image.

The text information generation unit 45 is an example of text information generation means and is implemented by instructions from the CPU 401 illustrated in FIG. 2. The text information generation unit 45 acquires a tacit knowledge comment from a tacit knowledge model or generates text information, based on a large language model 4005.

The update unit 46 is an example of update means and is implemented by instructions from the CPU 401 illustrated in FIG. 2. The update unit 46 updates a tacit knowledge model described below.

The processing unit 47 is implemented by instructions from the CPU 401 illustrated in FIG. 2, and performs processing for associating three-dimensional image information or a capture-generated image with speech text in accordance with processing requested by the user. The processing unit 47 performs processing for associating three-dimensional image information or a capture-generated image with generated information (an example of text information) that is generated based on the three-dimensional image information and the capture-generated image. Examples of the association processing include processing for displaying the three-dimensional image information or the capture-generated image and the speech text on a single screen. Examples of the association processing may include processing for displaying the three-dimensional image information, the capture-generated image, and the generated information on a single screen. The association processing may include, for example, processing for acquiring generated information, which is an example of text information, from a first tacit knowledge model 4004A or a second tacit knowledge model 4004B using the three-dimensional image information and the capture-generated image.

The determination unit 48 is implemented by instructions from the CPU 401 illustrated in FIG. 2, and determines which of the first tacit knowledge model 4004A and the second tacit knowledge model 4004B is to be used. The determination of which of the first tacit knowledge model 4004A and the second tacit knowledge model 4004B is to be used may be made in the following ways: selection by the user, and automatically (without confirming with the user) or semi-automatically (by recommending to the user and requesting confirmation) when a specific condition is satisfied. Examples of the specific condition include a condition where a question sentence included in input information (voice and/or characters) is related to an article (e.g., a state of an article). In this case, it is difficult to generate appropriate text information from the second tacit knowledge model 4004B. Thus, it is preferable to select the first tacit knowledge model 4004A.

The storing/reading unit 49 is an example of storage control means and is implemented by instructions from the CPU 401 illustrated in FIG. 2 and by the HD 404, the media I/F 411, and the DVD-RW drive 412 illustrated in FIG. 2. The storing/reading unit 49 stores various data in the storage unit 4000, the recording medium 411a, or the DVD-RW 412a and reads various data from the storage unit 4000, the recording medium 411a, or the DVD-RW 412a. The storage unit 4000, the recording medium 411a, and the DVD-RW 412a are examples of storage means.

The storage unit 4000 includes a three-dimensional image information management DB 4001, a model shape management DB 4002, a caption model 4003, the first tacit knowledge model 4004A, the second tacit knowledge model 4004B, the large language model 4005, and a captured image information management DB 4006.

The three-dimensional image information management DB 4001 manages three-dimensional image information of articles placed in a property. The three-dimensional image information is information on visual representations of articles (also referred to as models) placed in the property. The model shape management DB 4002 manages three-dimensional model shape information of the articles placed in the property. The image management server 40 can generate three-dimensional image information related to the property, based on the three-dimensional model shape information. The three-dimensional model shape information is information for drawing the articles in three dimensions, such as three-dimensional point clouds or three-dimensional models of the articles. The three-dimensional model shape information may include, for example, polygons or computer-aided design (CAD) models. The three-dimensional image information management DB 4001 or the model shape management DB 4002 preferably stores a wide-view image such as a spherical image of the property.

The caption model 4003 is generated by performing a learning process using combinations of images and caption comments as training data, and causes a computer to function to output a caption comment based on an image. The caption comment is explicit knowledge and is used as a term corresponding to implicit knowledge or tacit knowledge. The caption comment is text data and is a comment describing an image among, for example, comments expressed by voice or characters. A caption comment related to a property or an article is associated with identification information of the property or the article.

The first tacit knowledge model 4004A is generated by performing a learning process using, as training data, correspondences among three-dimensional image information, capture-generated images, and tacit knowledge (such as input information and speech text) with respect to the three-dimensional image information and the capture-generated images, and causes a computer to function to output a tacit knowledge comment based on an image. The first tacit knowledge model 4004A learns by associating information as follows: correspondences among three-dimensional image information, capture-generated images, and input information, correspondences among three-dimensional image information, capture-generated images, and speech text, and correspondences among three-dimensional image information, capture-generated images, speech text, and input information. The tacit knowledge comment is text data and is a comment excluding a caption comment, that is, a comment regarding content not represented in an image, among the comments expressed by voice or characters.

The second tacit knowledge model 4004B does not use a capture-generated image for learning. That is, the second tacit knowledge model 4004B is generated by performing a learning process using correspondences between three-dimensional image information of articles and input information as training data, and causes a computer to function to output a tacit knowledge comment based on the three-dimensional image information.

The large language model 4005 is a computer language model generated by performing a learning process using a vast amount of unlabeled text as training data. The large language model 4005 includes an artificial neural network having a large number of parameters. The large language model 4005 is sufficiently trained by a method for learning context, such as next sentence prediction or a masked language model, to capture much of the syntax and meaning of human language. The next sentence prediction understands context by determining whether sentence 1 and sentence 2 are consecutive. The masked language model understands context by masking a word in a sentence and predicting the masked word from the words before and after the masked word.

The captured image information management DB 4006 stores wide-view images in time series for management. The wide-view images are captured by the image capturing device 5 during, for example, a conference regarding the property. The wide-view images may be moving images. When a user of a communication terminal described below performs a capture operation, capture-generated images are stored. The term “capture” refers to storing, as a still image, a predetermined area indicating a predetermined-area image in a wide-view image. The captured image information management DB 4006 also stores speech text acquired from the conference management server 20 in association with timestamps of image capture for management. The speech text is text data converted from audio data recorded by the image capturing device 5 or the communication terminal during, for example, the conference.

### Three-Dimensional Image Information Management Table

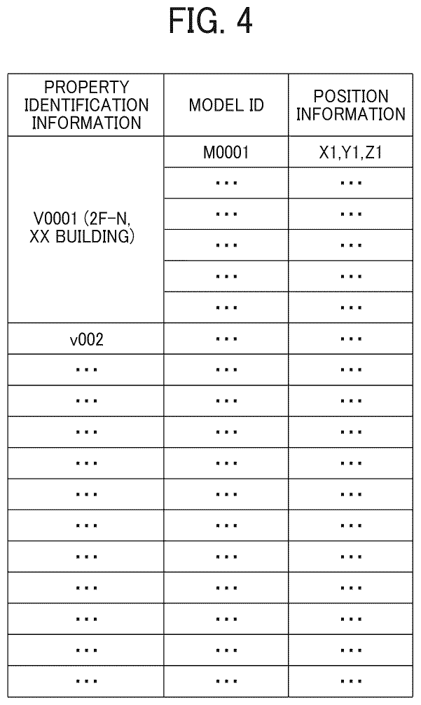

FIG. 4 is an illustration of an example of a three-dimensional image information management table according to the present embodiment. In the storage unit 4000, the three-dimensional image information management DB 4001 stores the three-dimensional image information management table as illustrated in FIG. 4. In the three-dimensional image information management table illustrated in FIG. 4, a model ID and position information are related to one another and managed in association with property identification information.

The property identification information is an example of property identification information for identifying a property. The term “property” refers to any space in which articles can be placed, such as a facility or a room in a facility. Articles to be placed vary depending on the functions of the facility. The property may be any property represented in a unit easy to manage, such as “2F-N, XX Building (meaning the north side of the second floor of XX Building)”.

The model ID is an example of a model ID for identifying an article placed in the property. The articles may be represented by three-dimensional model shape information such as polygons or CAD models in the model shape management DB 4002. With a model ID, three-dimensional image information is related to a three-dimensional model shape in the model shape management DB 4002.

The position information is information indicating the position of a model of an article in a three-dimensional virtual space using three-dimensional XYZ coordinates. The three-dimensional virtual space represents the property in a virtual space. The position information is indicated by, for example, three-dimensional coordinates of eight points defining a rectangular parallelepiped space occupied by a model.

This position information is measured as position information (latitude, longitude, and altitude) of the relay device 3 by a Global Navigation Satellite System (GNSS) satellite such as a Global Positioning System (GPS) satellite or by an indoor messaging system (IMES) serving as an indoor GPS. Technologies for indoor positioning include Wireless Fidelity (Wi-Fi) positioning, Radio Frequency Identifier (RFID) positioning, beacon positioning, pedestrian dead reckoning positioning, geomagnetism positioning, acoustic positioning, and ultra-wideband (UWB) positioning.

As described above, the position information illustrated in FIG. 4 is managed in association with the absolute position on the earth. In one example, by associating the origin (X=0, Y=0, Z=0) of the position information illustrated in FIG. 4 with the absolute position (latitude, longitude, and altitude) on the earth, all coordinates in the three-dimensional image, including the three-dimensional models or articles, are associated with the absolute positions on the earth. That is, three-dimensional image information and a capture-generated image are aligned in position with each other.

### Captured Image Information Management Table

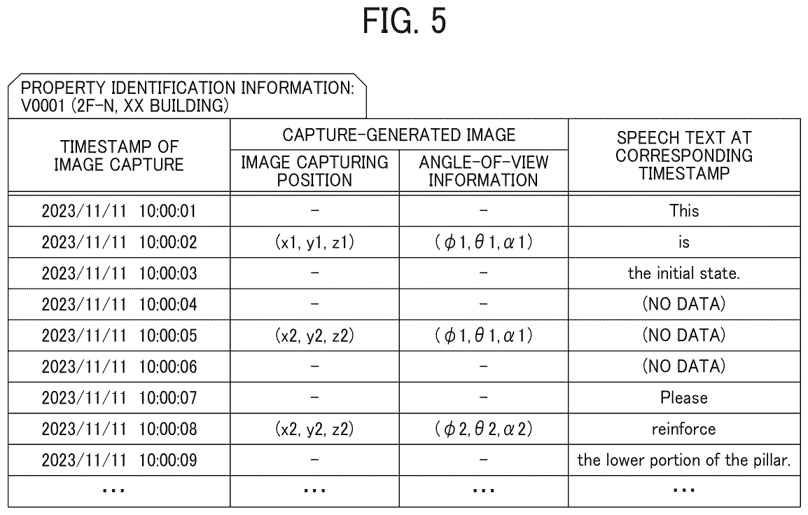

FIG. 5 is an illustration of an example of a captured image information management table according to the present embodiment. In the storage unit 4000, the captured image information management DB 4006 stores the captured image information management table as illustrated in FIG. 5. In the captured image information management table illustrated in FIG. 5, a timestamp of image capture, a wide-view image, a capture-generated image, an image capturing position, angle-of-view information, and speech text at the corresponding timestamp are related to each other and stored for management in association with property identification information. The position of the image capturing device 5 is measured by, for example, the GNSS of the relay device 3 to which the image capturing device 5 is attached. The timestamp of image capture indicates information on the date and time at which the capture-generated image is captured by the image capturing device 5. One or more capture-generated images are stored in association with a timestamp of image capture. The image capturing position indicates the position (absolute position on the earth) of the image capturing device 5 when a capture-generated image is captured. The capture-generated image is stored directly in the image management server 40. The angle-of-view information is information for specifying, on a wide-view image, a predetermined area indicating a predetermined-area image displayed on a communication terminal. As described below, the communication terminal is a terminal for viewing a real-time wide-view image in a conference. Speech text registered in the “speech text at the corresponding timestamp” column is speech text generated through speech recognition of audio captured by the image capturing device 5. The speech text at the corresponding timestamp is speech text transmitted from the conference management server 20.

### Functional Configuration of Conference Management Server

Reference is made back to FIG. 3. The conference management server 20 includes a transmission/reception unit 21, a screen generation unit 22, and a storing/reading unit 29. Each of these units is a function implemented by or means caused to function by any one or more of the hardware elements illustrated in FIG. 2 operating in accordance with instructions from the CPU 401 according to a program loaded onto the RAM 403 from the HD 404. The conference management server 20 further includes a storage unit 2000, which is implemented by the HD 404 illustrated in FIG. 2. The storage unit 2000 is an example of storage means.

In FIG. 3, the single conference management server 20 has all the functions described above. The conference management server 20 may be configured to implement the functions in a distributed manner across multiple computers.

The transmission/reception unit 21 is an example of a transmission unit or a reception unit and is implemented by instructions from the CPU 401 illustrated in FIG. 2 and by the communication I/F 407 illustrated in FIG. 2. The transmission/reception unit 21 transmits and receives various data (or information) to and from another terminal, device, apparatus, or system via the communication network N.

The screen generation unit 22 is an example of screen generation means and is implemented by instructions from the CPU 401 illustrated in FIG. 2. The screen generation unit 22 generates various screens. In a case where the terminal device 10 executes a web application, screen information is created by HTML, XML, CSS, JavaScript®, or the like. Thus, the screen information may be referred to as a web application. In a case where the terminal device 10 executes a client application, the screen information is stored in the terminal device 10, and the information to be displayed is transmitted in the form of, for example, XML.

The storing/reading unit 29 is an example of storage control means and is implemented by instructions from the CPU 401 illustrated in FIG. 2 and by the HD 404, the media I/F 411, and the DVD-RW drive 412 illustrated in FIG. 2. The storing/reading unit 29 stores various data in the storage unit 2000, the recording medium 411a, or the DVD-RW 412a and reads various data from the storage unit 2000, the recording medium 411a, or the DVD-RW 412a. The storage unit 2000, the recording medium 411a, and the DVD-RW 412a are examples of storage means.

### Conference Information Management Table

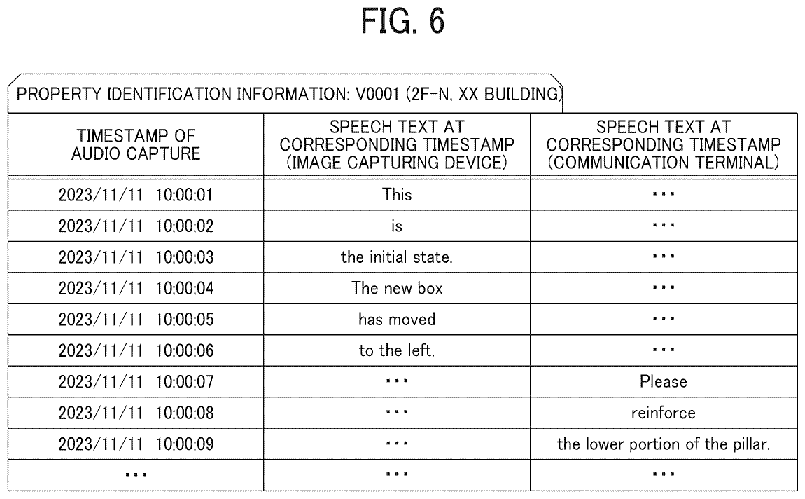

FIG. 6 is an illustration of an example of a conference information management table according to the present embodiment. The storage unit 2000 includes a conference information management DB 2001 storing the conference information management table as illustrated in FIG. 6.

In the conference information management table, a timestamp of audio capture, speech text at the corresponding timestamp (image capturing device), and speech text at the corresponding timestamp (communication terminal) are related to one another and stored for management in association with property identification information. The timestamp of audio capture indicates information on the date and time at which audio is captured by the image capturing device 5 or the communication terminal. Speech text registered in the “speech text at the corresponding timestamp (image capturing device)” column is speech text generated based on audio captured by the image capturing device 5. The speech text is comment data related to an article about which a participant in the conference has made an utterance while viewing the live images. Speech text registered in the “speech text at the corresponding timestamp (communication terminal)” column is speech text generated based on an utterance made by a user who is viewing live images on the communication terminal. The speech text is comment data related to an article about which a participant in the conference has made an utterance while viewing the live images.

### Transmission of Wide-View Image and Audio Data

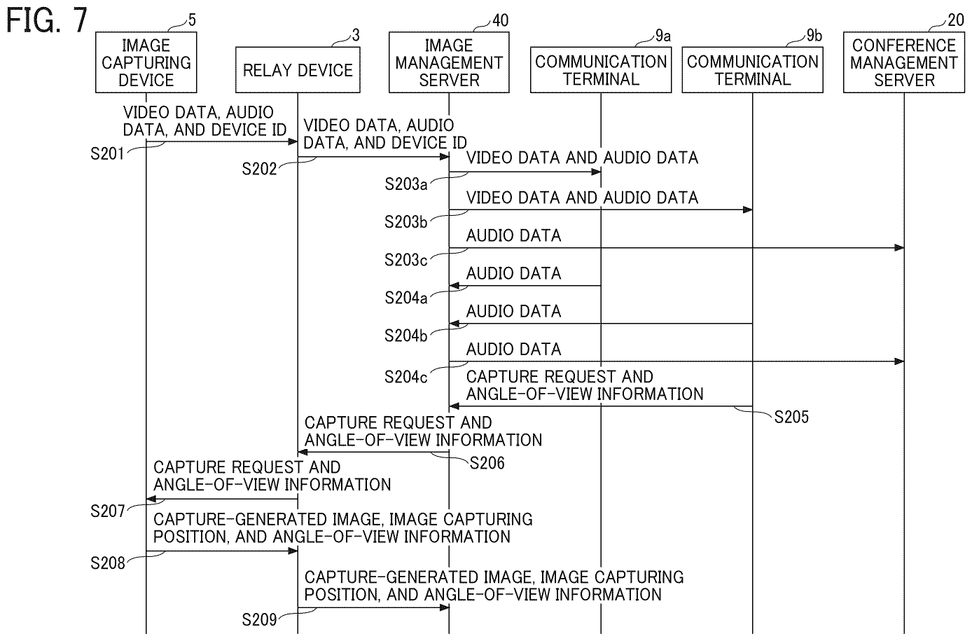

FIG. 7 is a sequence diagram illustrating a process of communicating a wide-view image and audio data. In the present embodiment, the image capturing device 5, a communication terminal 9a of a participant A, and a communication terminal 9b of a participant B participate in the same remote communication. The processing of S201 to S204c in FIG. 7 is repeatedly performed.

S201: The image capturing device 5 captures an image of surroundings and captures audio to obtain video data (wide-view image) and audio data, and transmits the video data and the audio data to the relay device 3. The image capturing device 5 also transmits a device ID for identifying the image capturing device 5 in order to identify a property. Accordingly, the relay device 3 acquires the video data and the audio data. In the image management server 40, the device ID and the property are associated with each other in advance.

S202: The relay device 3 transmits the video data, the audio data, and the device ID, which have been acquired, to the image management server 40 via the communication network N. In the image management server 40, accordingly, the transmission/reception unit 41 receives the video data, the audio data, and the device ID. The image management server 40 identifies the property by the device ID. As a result, wide-view images and timestamps of image capture are stored in the captured image information management DB 4006, for example, every second by the storing/reading unit 49. The wide-view images may be distributed as live images without being stored.

S203a: The image management server 40 reads participant IDs of participants in the same conference as the image capturing device 5 from, for example, conference information. The image management server 40 also reads IP addresses of the communication terminals 9a and 9b, based on the read participant IDs. The image management server 40 refers to the IP address of the communication terminal 9a and transmits the received video data and audio data to the communication terminal 9a. Accordingly, the communication terminal 9a receives the video data and the audio data and displays a wide-view image while outputting audio.

S203b: Likewise, the image management server 40 refers to the IP address of the communication terminal 9b and transmits the video data and the audio data to the communication terminal 9b. Accordingly, the communication terminal 9b displays a wide-view image while outputting audio.

S203c: Further, the image management server 40 calls the API of the conference management server 20 to transmit the audio data to the conference management server 20. Thus, the transmission/reception unit 21 of the conference management server 20 receives the audio data. The conference management server 20 (or an existing speech recognition server) uses the audio data to convert an audio portion into text and generates text data (hereinafter referred to as speech text). The storing/reading unit 29 stores the speech text at the corresponding timestamp (image capturing device) in the conference information management DB 2001.

S204a and S204b: The communication terminals 9a and 9b transmit audio data of the participant A and audio data of the participant B to the conference management server 20, respectively. The audio data of the participant A and the audio data of the participant B are converted from utterances made by the participants A and B operating the communication terminals 9a and 9b, respectively, and acquired by respective microphones.

S204c: The image management server 40 calls the API of the conference management server 20 to transmit the audio data to the conference management server 20. Thus, the transmission/reception unit 21 of the conference management server 20 receives the audio data. The conference management server 20 (or an existing speech recognition server) uses the audio data to convert an audio portion into text and generates text data. The storing/reading unit 29 stores the speech text at the corresponding timestamp (communication terminal) in the conference information management DB 2001.

S205: The participant A of the communication terminal 9a and the participant B of the communication terminal 9b (in FIG. 7, the participant B) can change the point of view of the video data, which is the wide-view image. The participant B can perform a capture operation at any time when the participant B desires to store a predetermined-area image that is a portion of a wide-view image displayed with a changed point of view. In response to acceptance of the capture operation, the communication terminal 9b transmits a capture request and angle-of-view information indicating the predetermined area currently displayed on a display of the communication terminal 9b to the image management server 40.

S206: In response to receiving the capture request and the angle-of-view information, the image management server 40 identifies the IP address of the relay device 3 participating in the same conference as the communication terminal 9b and transmits the capture request and the angle-of-view information to the relay device 3.

S207: The relay device 3 receives the capture request and the angle-of-view information and transfers the capture request and the angle-of-view information to the image capturing device 5.

S208: In response to receiving the capture request, the image capturing device 5 generates a capture-generated image based on the angle-of-view information. The image capturing device 5 transmits the capture-generated image, the image capturing position, and the angle-of-view information to the relay device 3. When the image capturing device 5 is in a fixed location, the image capturing position of the image capturing device 5 may be registered in the image management server 40 in advance.

S209: The relay device 3 transmits the capture-generated image, the image capturing position, and the angle-of-view information to the image management server 40. The image management server 40 identifies the property by the device ID in a manner similar to that in step S202. The storing/reading unit 49 stores the capture-generated image, the image capturing position, and the angle-of-view information in the captured image information management DB 4006.

As a result of the process described above, a capture-generated image captured from a wide-view image, an image capturing position, and angle-of-view information are stored in the captured image information management DB 4006. The conference information management DB 2001 stores the speech text transmitted from the image capturing device 5, the speech text transmitted from the communication terminal 9a, and the speech text transmitted from the communication terminal 9b. As described below, speech text stored in the conference information management DB 2001 may be transmitted to the captured image information management DB 4006.

### Example of Model Update and Text Information Generation

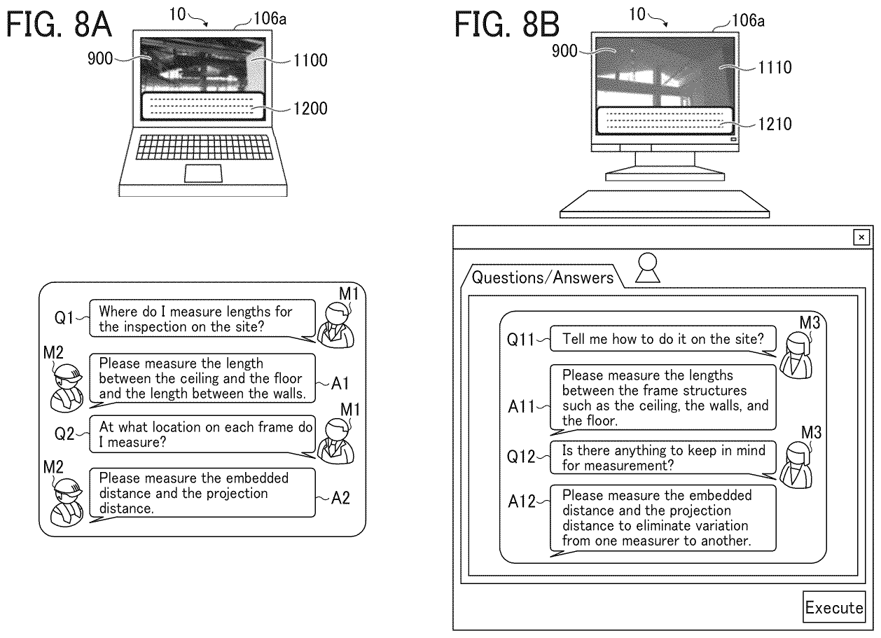

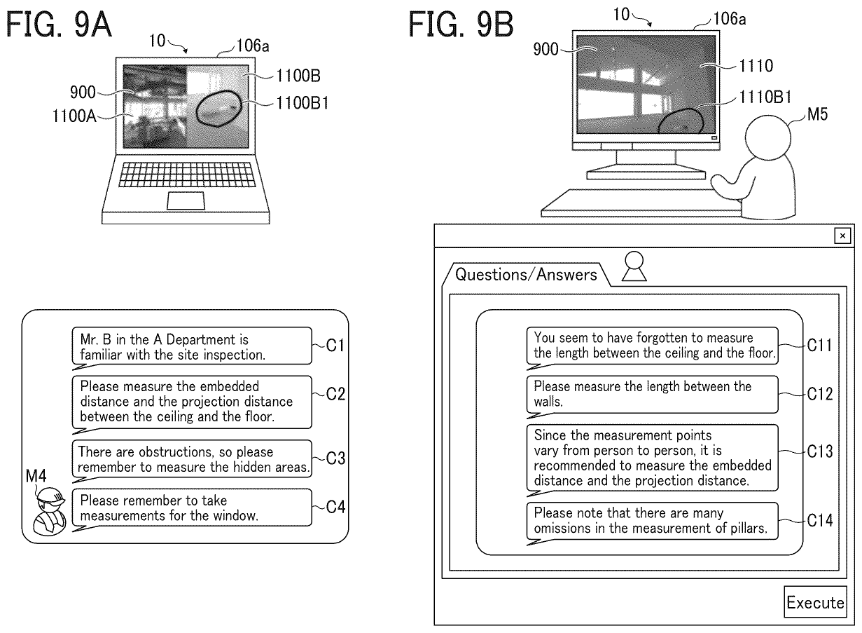

A model update method and a text information generation method will be described with reference to FIGS. 8A, 8B, 9A, and 9B. While speech text is not used for model update and text information generation in FIGS. 8A, 8B, 9A, and 9B, utterances described below, such as an utterance Q1, may be replaced with speech text or speech text may be added to the utterances described below to perform learning in a similar manner.

FIGS. 8A and 8B are diagrams illustrating screens displayed on the terminal device 10 in a model update process and a text information generation process, respectively. FIG. 8A illustrates the model update process. The display control unit 13 of the terminal device 10 controls the display 106a to display a display screen 900 received from the image management server 40. The display screen 900 includes a target image 1100 and text 1200.

The input reception unit 12 of the terminal device 10 receives voice information from the microphone 109b as input information input by data providers on the displayed display screen 900. The voice information indicates utterances Q1, A1, Q2, and A2 made by data providers M1 and M2. The data providers M1 and M2 preferably have a wealth of knowledge including tacit knowledge regarding the business. A tacit knowledge model is updated based on such interactions between the data providers M1 and M2, thus allowing a user to obtain useful tacit knowledge comments.

The identifying unit 44 identifies the target image 1100, which is a portion excluding the text 1200 from the display screen 900.

Then, the decision unit 43 determines the levels of relevance between a caption comment acquired from the caption model 4003 using the target image 1100 and the utterances Q1, A1, Q2, and A2.

The update unit 46 updates the tacit knowledge model using the target image 1100 or the like and, as training data, a tacit knowledge comment that is a comment determined to have a low level of relevance among the utterances Q1, A1, Q2, and A2, and updates the caption model 4003 using the target image 1100 and, as training data, a caption comment that is a comment determined to have a high level of relevance among the utterances Q1, A1, Q2, and A2.

Thus, the tacit knowledge model is trained on the correspondences between the target image 1100 and the utterances Q1, A1, Q2, and A2. Features of the target image 1100 are extracted using some feature extraction models suitable for images, such as convolutional neural network (CNN) models. The features represent, for example, objects that appear in an image and positions of the objects appearing in the image, or operations that are being performed in the image. Thus, the tacit knowledge model can learn the correspondences between the features of the image and the utterances Q1, A1, Q2, and A2.

FIG. 8B illustrates the text information generation process. The display control unit 13 of the terminal device 10 controls the display 106a to display a display screen 900 received from the image management server 40. The display screen 900 includes an image 1110 and text 1210.

The input reception unit 12 of the terminal device 10 receives voice information via the microphone 109b as input information input by a user on the displayed display screen 900. The voice information indicates questions Q11 and Q12 uttered by a user M3.

The identifying unit 44 identifies the image 1110, which does not include the text 1210, as a target image.

The text information generation unit 45 uses the image 1110 to acquire a tacit knowledge comment, based on the tacit knowledge model. The tacit knowledge model extracts features from the image 1110, determines that the features of the image 1110 illustrated in FIG. 8B are similar to those of the image 1110 at the time of update, and can identify the utterances Q1, A1, Q2, and A2 related to the image 1110. The utterances Q1, A1, Q2, and A2 are set as tacit knowledge comments.

Further, the text information generation unit 45 uses, for example, the tacit knowledge comments (i.e., the utterances Q1, A1, Q2, and A2) and the questions Q11 and Q12 to generate text information regarding answers A11 and A12 to the questions Q11 and Q12, respectively, based on the large language model 4005.

The display control unit 13 of the terminal device 10 controls the display 106a to display text information regarding the answers A11 and A12 received from the image management server 40.

FIGS. 9A and 9B are diagrams illustrating other screens displayed on the terminal device 10 in the model update process and the text information generation process, respectively, according to the present embodiment. FIGS. 9A and 9B illustrate a case in which no question sentence is used for model update and text information generation.

FIG. 9A illustrates the model update process. In an example illustrated in FIG. 9A, the tacit knowledge model is updated using voice information of one data provider and a partial image, rather than a conversation between data providers.

The display control unit 13 of the terminal device 10 controls the display 106a to display a display screen 900 received from the image management server 40. The display screen 900 includes a first image 1100A and a second image 1100B.

The input reception unit 12 of the terminal device 10 receives character information from the keyboard 110a as input information input by a data provider on the displayed display screen 900. The character information indicates comments C1 to C4 made by a data provider M4.

The input reception unit 12 also receives operation information from the mouse 110b as input information input by the data provider M4 on the displayed display screen 900. The operation information indicates an operation performed by the data provider M4 to identify a partial image 1100B1 in the second image 1100B.

The identifying unit 44 may identify the partial image 1100B1 as the target image, or may identify the first image 1100A or the second image 1100B as the target image.

Then, the decision unit 43 determines the levels of relevance between the caption comment acquired from the caption model 4003 using the target image and the comments C1 to C4.

The update unit 46 updates the tacit knowledge model using the partial image 1100B1 or the like and, as training data, a tacit knowledge comment that is a comment determined to have a low level of relevance among the comments C1 to C4, and updates the caption model 4003 using the partial image 1100B1 and, as training data, a caption comment that is a comment determined to have a high level of relevance among the comments C1 to C4.

Thus, the tacit knowledge model is trained on the correspondences between the partial image 1100B1 and the comments C1 to C4. Features of the partial image 1100B1 are extracted using some feature extraction models suitable for images, such as CNN models. The features represent, for example, objects that appear in an image and positions of the objects appearing in the image, or operations that are being performed in the image. Thus, the tacit knowledge model can learn the correspondences between the features of the image and the comments C1 to C4.

FIG. 9B illustrates the text information generation process. The display control unit 13 of the terminal device 10 controls the display 106a to display a display screen 900 received from the image management server 40. The display screen 900 includes an image 1110.

A user M5 does not perform an input on the displayed display screen 900, and the input reception unit 12 does not receive input information input by a user on the displayed display screen 900. The identifying unit 44 identifies the image 1110, which is the entire display screen 900, as the target image.

When the user M5 performs an operation to identify the partial image 1100B1 on the display screen 900, the input reception unit 12 receives, as input information, operation information indicating the operation of identifying the partial image 1100B1, from the mouse 110b. In this case, the identifying unit 44 identifies the partial image 1100B1 on the display screen 900 as the target image in accordance with the operation information.

The text information generation unit 45 uses the partial image 1100B1 to acquire a tacit knowledge comment, based on the tacit knowledge model. The tacit knowledge model determines that the features of an image 1110B1 illustrated in FIG. 9B are similar to the features of the image 1110B1 at the time of update, and can identify the comments C1 to C4 related to the image 1110B1. The tacit knowledge model extracts the comments C1 to C4 as tacit knowledge comments. The text information generation unit 45 uses, for example, the tacit knowledge comments to generate text information regarding comments C11 to C14, based on the large language model 4005. The text information generation unit 45 may generate the text information using a preset standard question when no question sentence is input, rather than using a method that does not use any questions at all.

The display control unit 13 of the terminal device 10 controls the display 106a to display the text information regarding the comments C11 to C14 received from the image management server 40.

### Operations or Processes

### Learning Phase (Model Update)

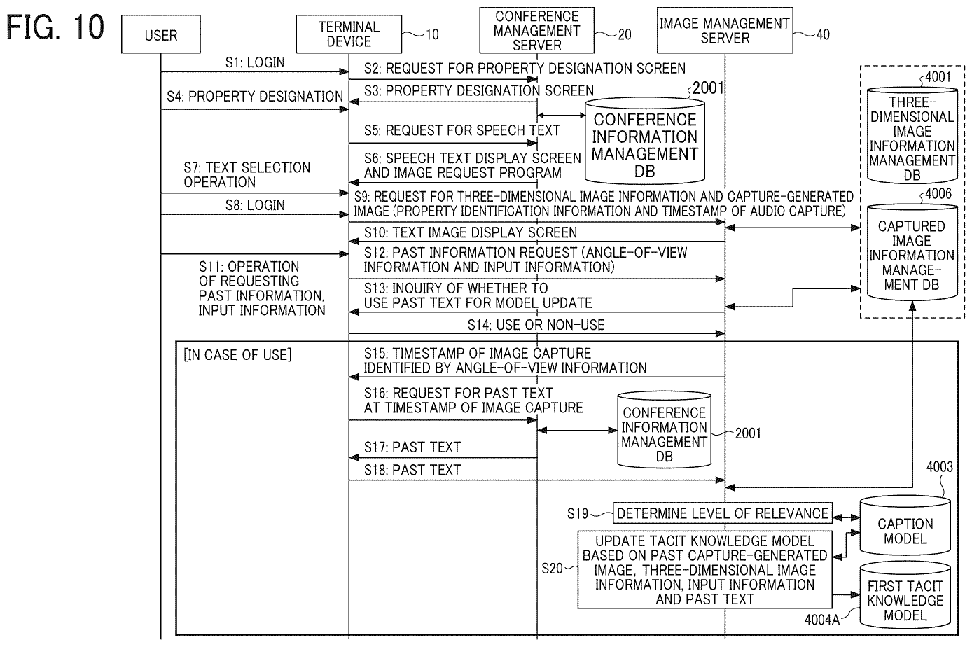

First, a model update process in which the first tacit knowledge model 4004A is trained on data will be described with reference to FIG. 10. FIG. 10 is a sequence diagram illustrating an example of the model update process.

S1: A user inputs a login operation to the terminal device 10. This login is to log in to the conference management server 20. The input reception unit 12 of the terminal device 10 accepts the login operation. Any existing method may be used to perform the login. The following description is given on the assumption that the login is successful.

The user logs in to the conference management server 20 and then logs in to the image management server 40. Alternatively, the user may log in to the image management server 40 first and then log in to the conference management server 20.

S2: In response to a successful login, the transmission/reception unit 11 of the terminal device 10 transmits a request for a property designation screen 200 to the conference management server 20.

S3: The transmission/reception unit 21 of the conference management server 20 receives the request for the property designation screen 200. The screen generation unit 22 generates the property designation screen 200, and the transmission/reception unit 21 transmits screen information of the property designation screen 200 to the terminal device 10.

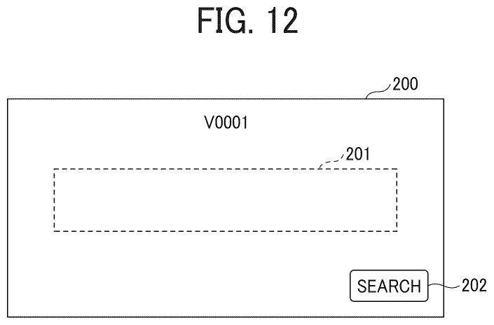

S4: The transmission/reception unit 11 of the terminal device 10 receives the screen information of the property designation screen 200. The display control unit 13 displays the property designation screen 200 (see FIG. 12). The user enters property identification information (e.g., V0001; 2F-N, XX Building) on the displayed property designation screen 200. The input reception unit 12 of the terminal device 10 receives the property identification information.

S5: The transmission/reception unit 11 of the terminal device 10 transmits a request for speech text for which the property identification information is designated to the conference management server 20.

S6: The transmission/reception unit 21 of the conference management server 20 receives the request for speech text, and the storing/reading unit 29 searches the conference information management DB 2001 using the property identification information. The screen generation unit 22 of the conference management server 20 generates a speech text display screen 210 for displaying speech text, and the transmission/reception unit 21 transmits screen information of the speech text display screen 210 to the terminal device 10.

In response to the request for speech text, the transmission/reception unit 21 also transmits an image request program to the terminal device 10 so that the terminal device 10 can acquire three-dimensional image information. The image request program is, for example, a web application. The web application is installed in the conference management server 20 by the operator of the image management server 40 under the permission of the operator of the conference management server 20. Alternatively, a uniform resource locator (URL) at which the image request program is available may be transmitted to the terminal device 10. The web application, which is configured to acquire three-dimensional image information from the image management server 40, has a function of connecting the terminal device 10 to the image management server 40 to request or display the three-dimensional image information.

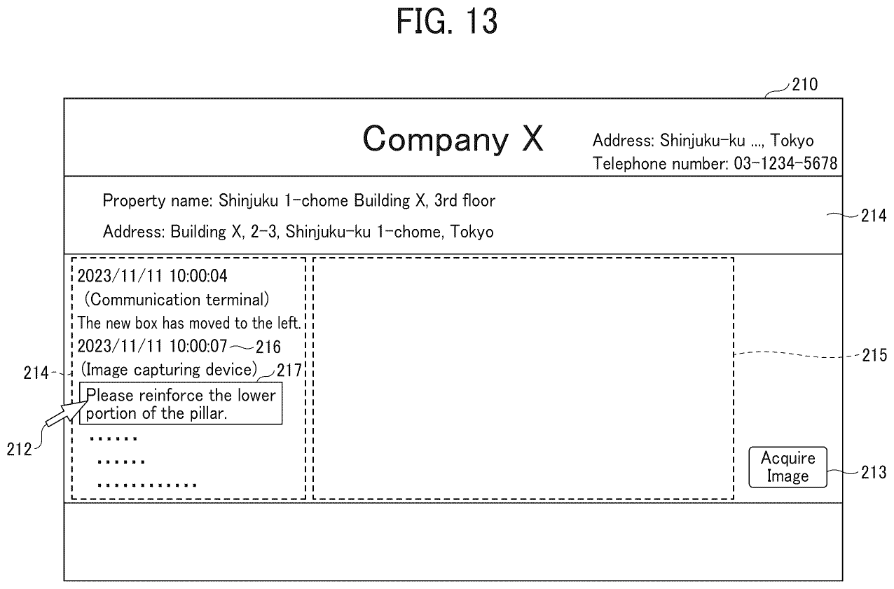

S7: The transmission/reception unit 11 of the terminal device 10 receives the screen information of the speech text display screen 210 and the image request program. The display control unit 13 displays the speech text display screen 210 (see FIG. 13). As a result, the speech text related to the property is displayed. The user performs an operation of selecting any speech text on the displayed speech text display screen 210. The user can select speech text by referring to an article name included in the speech text. Speech text is selected in order to display three-dimensional image information and a capture-generated image that are identified by the speech text. When speech text is selected, the timestamp of audio capture is also identified. The input reception unit 12 of the terminal device 10 accepts the operation of selecting speech text.

After selecting speech text, the user performs an operation of requesting a capture-generated image and three-dimensional image information of the property (e.g., pressing an image acquisition button 213). The user may be allowed to request three-dimensional image information and a capture-generated image by selecting speech text. The input reception unit 12 of the terminal device 10 accepts the operation of requesting a capture-generated image and three-dimensional image information of the property. The three-dimensional image information of the property is three-dimensional image information of articles placed in the property, which is generated as a virtual space. The articles are represented by 3D model shape information.

The speech text display screen 210 includes a first display area 214 and a second display area 215. The first display area 214 displays speech text acquired from the conference management server 20. The second display area 215 displays the capture-generated image and the three-dimensional image information of the articles acquired from the image management server 40. In step S7, the speech text is displayed in the first display area 214, whereas no information is displayed in the second display area 215.

S8: If the user has not logged in to the image management server 40, the user inputs a login operation to the terminal device 10. The login operation is to log in to the image management server 40. The input reception unit 12 of the terminal device 10 accepts the login operation. Any existing method may be used to perform the login. The following description is given on the assumption that the login is successful. The login operation by the user may be omitted using, for example, single sign-on.

S9: The terminal device 10 executes the image request program to request three-dimensional image information. Accordingly, the transmission/reception unit 11 designates the property identification information of the property selected by the user and the timestamp of audio capture and transmits a request for a capture-generated image and three-dimensional image information of the property to the image management server 40. The capture-generated image is a captured image of the same property as that of the three-dimensional image information. Preferably, the transmission/reception unit 11 transmits the URL of the conference management server 20 to the image management server 40 so that the terminal device 10 can be redirected to the conference management server 20. The three-dimensional image information of the property is an image of articles placed in the property defined as a virtual space. Since the articles are represented by 3D model shape information, the terminal device 10 projects three-dimensional model shapes of the articles into two dimensions to generate a planar image. The user can view any article while changing the point of view. The transmission/reception unit 11 may transmit the property management information acquired from the conference management server 20 to the image management server 40. For example, the image request program receives the property management information as a URL parameter from a web application connected to the conference management server 20.

S10: The transmission/reception unit 41 of the image management server 40 receives the request for a capture-generated image and three-dimensional image information of the property. The storing/reading unit 49 searches the three-dimensional image information management DB 4001 using the property identification information and acquires three-dimensional image information of each article. The storing/reading unit 49 further searches the captured image information management DB 4006 using the property identification information and acquires a capture-generated image (an example of a two-dimensional image) associated with the timestamp of image capture closest to the timestamp of audio capture, position information, and angle-of-view information. The processing unit 47 requests the screen generation unit 42 to generate a screen including the capture-generated image and the three-dimensional image information of the property. The screen generation unit 42 generates three-dimensional image information by placing a virtual camera at a position indicated by the position information and determining the angle of view of the virtual camera based on the angle-of-view information. As a result, the three-dimensional image information has the same angle of view as the capture-generated image. The screen generation unit 42 generates a screen corresponding to the second display area 215 in which the capture-generated image and the three-dimensional image information of each article are arranged on one screen.

The transmission/reception unit 41 transmits screen information of the screen corresponding to the second display area 215 to the terminal device 10. The three-dimensional image information of each article, which is included in the screen information, is three-dimensional image information in which all the articles included in the property are placed in the property, and the user can change the point of view as desired.

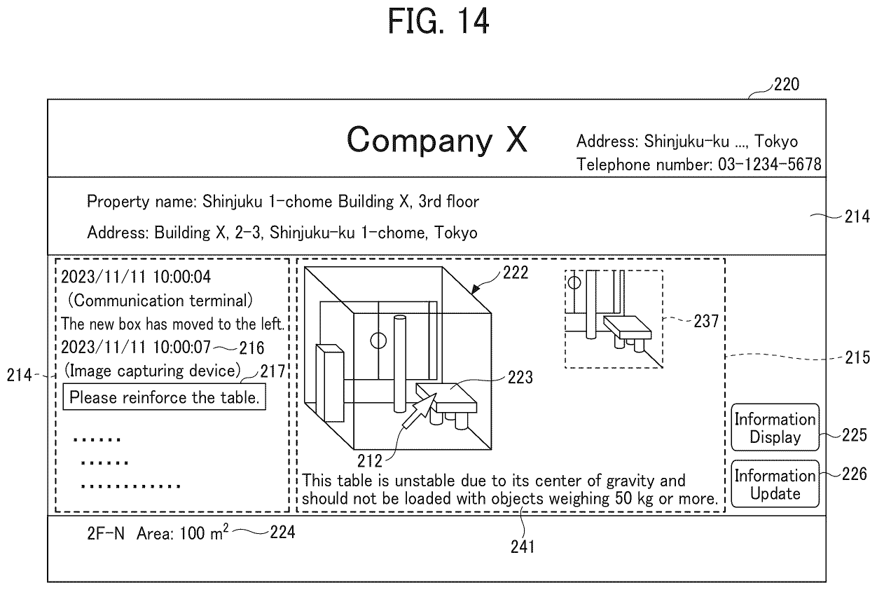

S11: The transmission/reception unit 11 of the terminal device 10 receives the screen information of the screen corresponding to the second display area 215, and the display control unit 13 displays a text image display screen 220 including the first display area 214 and the second display area 215 (see FIG. 14). In step S11, the capture-generated image and the three-dimensional image information of each article are displayed in the second display area 215, and the capture-generated image and the three-dimensional image information have the same point of view. Note that the point of view is changeable for the three-dimensional image information.

The user can change the point of view of the three-dimensional image information and enlarge an article. The user performs an operation of requesting past information. The past information includes a capture-generated image older than the capture-generated image displayed in step S11 (the older capture-generated image is hereinafter referred to as a past capture-generated image) and speech text older than the selected speech text. For example, the user may press an information display button 225 to perform an operation of requesting past information. The input reception unit 12 of the terminal device 10 accepts the operation of requesting past information. The user may be allowed to specify a specific past timestamp. While past information is requested in the present embodiment, the user may be allowed to request information later than the speech text selected in step S7.

Further, the coordinates of a position clicked by the user with a mouse pointer or the model ID of an article identified by the coordinates is transmitted to the image management server 40.

The user inputs comments related to the article, such as the comments (character information or voice) described with reference to FIGS. 8A, 8B, 9A, and 9B, to the terminal device 10. The comments may be referred to as input information. The input information may be a tacit knowledge comment. The input information may include a caption comment describing the article.

S12: In response to the user pressing an information update button 226, the transmission/reception unit 11 of the terminal device 10 transmits a past information request (angle-of-view information and input information) to the image management server 40.

S13: The transmission/reception unit 41 of the image management server 40 receives the past information request. The storing/reading unit 49 searches the captured image information management DB 4006 and identifies the angle-of-view information closest to the received angle-of-view information among items of angle-of-view information older than the timestamp of audio capture transmitted in step S9. The storing/reading unit 49 acquires the timestamp of image capture associated with the identified angle-of-view information. It may not be possible to find exactly the same angle-of-view information as the received angle-of-view information in the captured image information management DB 4006. Accordingly, the storing/reading unit 49 searches the captured image information management DB 4006 and identifies angle-of-view information indicating an angle of view having a difference within a certain range. A range indicating how far back in time to search may be set in advance. When a plurality of items of angle-of-view information match, the storing/reading unit 49 identifies the latest item of angle-of-view information. The user may be allowed to set the range of difference and the range indicating how far back in time to search.

The storing/reading unit 49 further acquires a capture-generated image (i.e., past capture-generated image) associated with the timestamp of image capture from the captured image information management DB 4006.

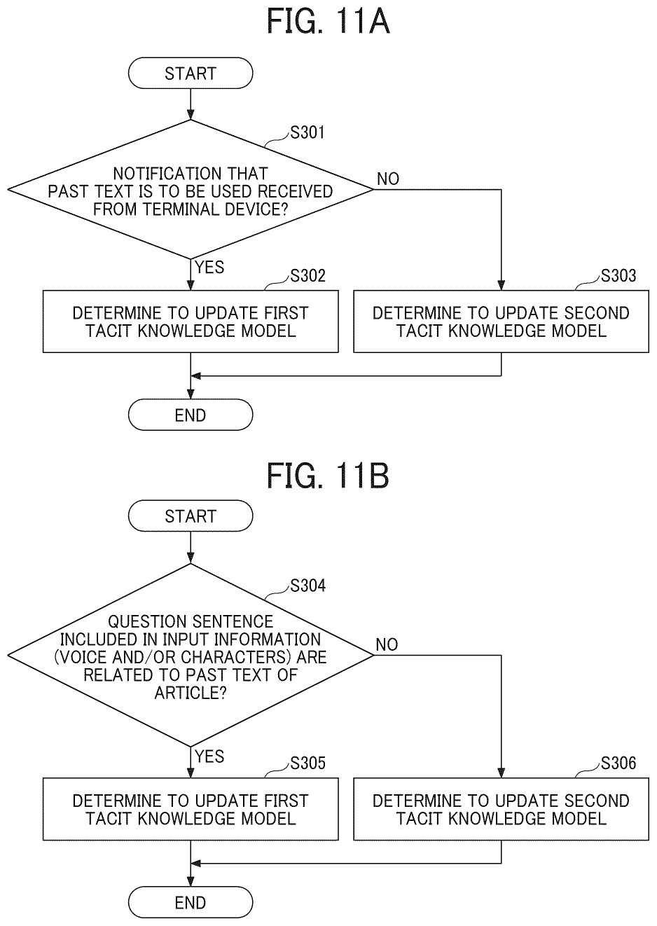

Subsequently, the determination unit 48 determines to inquire of the user in order to determine which of the first tacit knowledge model 4004A and the second tacit knowledge model 4004B is to be updated. The transmission/reception unit 41 inquires of the terminal device 10 whether past text is to be used for model update. The past text will be described in detail below. A determination process performed by the determination unit 48 will be described with reference to FIGS. 11A and 11B.

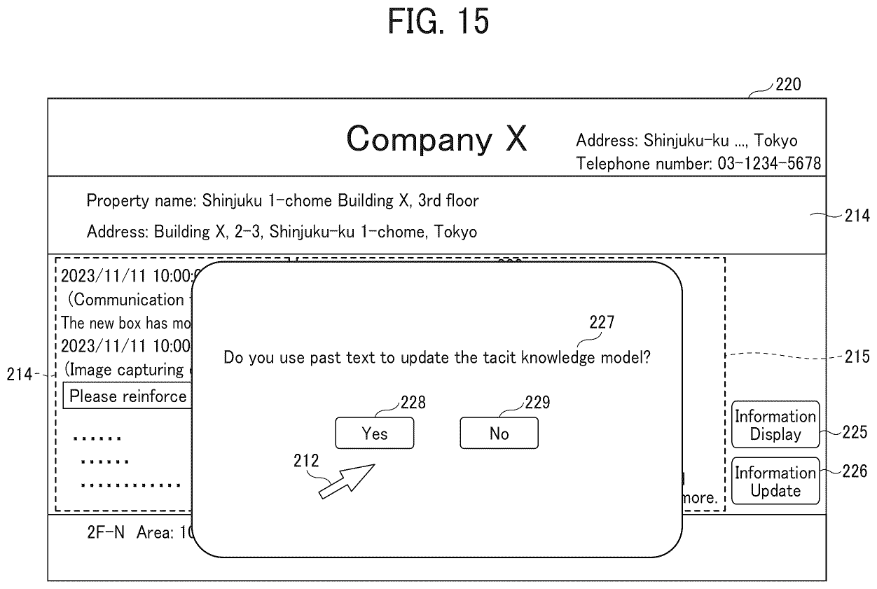

S14: The transmission/reception unit 11 of the terminal device 10 receives the inquiry, and the display control unit 13 causes a message 227 as to whether to use past text for model update (see FIG. 15) to be displayed on the text image display screen 220. The user confirms the message 227 and presses a “YES” (i.e., use) button 228 or a “NO” (i.e., non-use) button 229. The input reception unit 12 accepts the pressing of the “YES” button 228 or the “NO” button 229. The transmission/reception unit 11 of the terminal device 10 transmits the selected option (use or non-use) to the image management server 40. The transition from the screen illustrated in FIG. 14 to the screen illustrated in FIG. 15 may be performed by the terminal device 10 without communication with the image management server 40.

S15: Since the transmission/reception unit 41 of the image management server 40 receives the selected option (use or non-use), the determination unit 48 determines whether past text is to be used, based on the selected option (use or non-use). FIG. 10 illustrates a case where past text is to be used. The transmission/reception unit 41 of the image management server 40 transmits the timestamp of image capture identified by the angle-of-view information to the terminal device 10 in order to acquire past text.

S16: The transmission/reception unit 11 of the terminal device 10 receives a request for past text together with the timestamp of image capture identified by the angle-of-view information. For example, the image management server 40 notifies the terminal device 10 of the URL of the conference management server 20 and redirects the terminal device 10 to the conference management server 20. Accordingly, the transmission/reception unit 11 of the terminal device 10 transmits the request for past text for which the timestamp of image capture identified by the angle-of-view information is designated to the conference management server 20.

S17: The transmission/reception unit 21 of the conference management server 20 receives the request for past text, and the storing/reading unit 29 searches the conference information management DB 2001 for a timestamp of audio capture by using the received timestamp of image capture. The storing/reading unit 29 acquires, from the conference information management DB 2001, the speech text at the corresponding timestamp (image capturing device) and the speech text at the corresponding timestamp (communication terminal) associated with a timestamp of audio capture that is the same as or the closest to the timestamp of image capture. Such speech text is hereinafter referred to as past text (an example of second text data). The transmission/reception unit 21 transmits the acquired past text to the terminal device 10.

S18: In response to receiving the past text, the transmission/reception unit 11 of the terminal device 10 transmits the past text to the image management server 40. The transmission/reception unit 41 of the image management server 40 receives the past text as a response to the request in step S15. The storing/reading unit 49 stores the past text in the captured image information management DB 4006 in association with the timestamp of image capture identified in step S12. Accordingly, the speech text is associated with the capture-generated image.

S19: The decision unit 43 acquires a caption comment identified by the model ID (transmitted in step S12) from the caption model 4003, and determines a level of relevance between the caption comment and a comment included in the past text and the input information received in step S12. In one example, the decision unit 43 may determine the level of relevance of the entire comment included in the past text and the input information received in step S12 to the acquired caption comment. In another example, the decision unit 43 may divide the comment included in the past text and the input information received in step S12 into multiple comments and determine a level of relevance of each of the divided comments to the acquired caption comment.

S20: The update unit 46 updates the caption model 4003 by associating a comment determined to have a high level of relevance in step S19 and included in the past text and the input information, as a caption comment, with the model ID. The update unit 46 also updates the first tacit knowledge model 4004A using, as training data, a comment determined to have a low level of relevance in step S19 and included in the past text and the input information, three-dimensional image information (in which an image represented by the angle-of-view information in step S12 is set as a predetermined-area image), and the past capture-generated image. That is, the correspondences among the three-dimensional image information and the past capture-generated image of the article, the past text, and the input information are learned. Features of the three-dimensional image information and the past capture-generated image of the article are extracted using some feature extraction models suitable for images, such as CNN models. The features represent, for example, objects that appear in an image and positions of the objects appearing in the image, or operations that are being performed in the image. Thus, the first tacit knowledge model 4004A can learn the correspondences among the features of the three-dimensional image information and the past capture-generated image of the article, the past text, and the input information.

The update unit 46 may update the first tacit knowledge model 4004A without using one of the three-dimensional image information and the past capture-generated image of the article.

Both the past text and the input information are not to be used, and at least one of them may be used to update the first tacit knowledge model 4004A.

The update unit 46 may further use, for learning, the speech text selected in step S7 and a capture-generated image captured at date and time indicated by the timestamp of image capture closest to the timestamp of audio capture of the speech text selected in step S7. However, the timestamp of audio capture and the timestamp of image capture may or may not be close to each other, and thus may be used by the update unit 46 for learning when the difference between the timestamp of audio capture and the timestamp of image capture is within a predetermined amount of time.

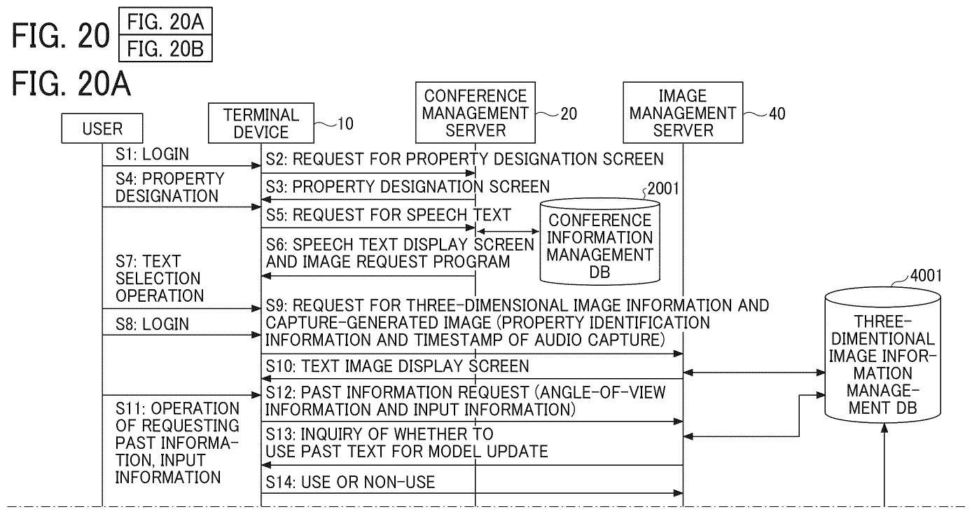

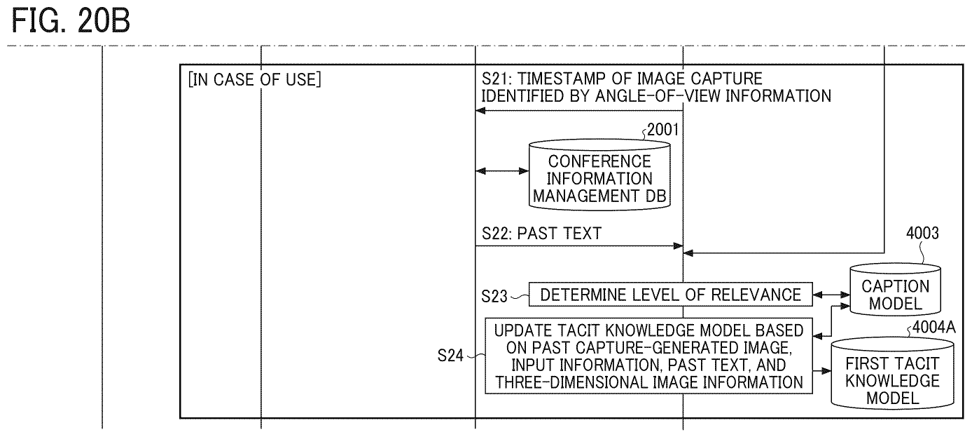

In FIG. 10, the image management server 40 acquires the past text from the terminal device 10. Alternatively, as illustrated in FIG. 20, the image management server 40 may acquire the past text from the conference management server 20.

FIGS. 11A and 11B are flowcharts illustrating a process in which the determination unit 48 determines whether to update the first tacit knowledge model 4004A or the second tacit knowledge model 4004B. First, in FIG. 11A, the determination unit 48 determines whether a notification has been received from the terminal device 10 that past text is to be used (step S301).

If the determination in step S301 is “YES”, the determination unit 48 determines to update the first tacit knowledge model 4004A (step S302).

If the determination in step S301 is “NO”, the determination unit 48 determines to update the second tacit knowledge model 4004B (step S303).

In FIG. 11B, the determination unit 48 determines whether a question sentence included in input information (voice and/or characters) received from the terminal device 10 is related to past text of an article (step S304).

If the determination in step S304 is “YES”, the determination unit 48 determines to update the first tacit knowledge model 4004A (step S305).

If the determination in step S304 is “NO”, the determination unit 48 determines to update the second tacit knowledge model 4004B (step S306).

While model updating is illustrated as an example in FIGS. 11A and 11B, the illustrated processes are also applicable to selection of a model to be used to generate text information.

### Example Screens

FIG. 12 illustrates an example of the property designation screen 200 for inputting property identification information. The property designation screen 200 includes a property identification information input field 201 and a search button 202. In response to the user entering property identification information in the property identification information input field 201 and pressing the search button 202, the speech text display screen 210 illustrated in FIG. 13 is displayed.

FIG. 13 illustrates an example of the speech text display screen 210. The speech text display screen 210 includes a first display area 214 and a second display area 215. The first display area 214 displays speech text acquired from the conference management server 20. The second display area 215 displays the three-dimensional image information or the like of the articles acquired from the image management server 40. The first display area 214 is an area other than the second display area 215. The first display area 214 includes speech text captured during a conference regarding the property identified by the property identification information. The user uses a mouse cursor 212 to select speech text 217 related to an article for which the capture-generated image is to be displayed. When speech text is selected, a timestamp of audio capture 216 is also identified. In response to the user pressing the image acquisition button 213, the text image display screen 220 illustrated in FIG. 14 is displayed.

While the second display area 215 is an area other than the first display area 214, display may be implemented by a program on a web application such as an iframe.

FIG. 14 is a diagram illustrating an example of the text image display screen 220. The text image display screen 220 includes speech text, a capture-generated image 237, and three-dimensional image information 222 at a time. The first display area 214 is similar to that illustrated in FIG. 13.

The second display area 215 of the text image display screen 220 displays the capture-generated image 237 and three-dimensional image information 223 of a table. The second display area 215 also displays input information 241 input by the user, stating: “This table is unstable due to its center of gravity and should not be loaded with objects weighing 50 kg or more”.

In FIG. 14, a size (floor area) 224 is further displayed as information related to the property. The size (floor area) 224 may be a measured value or may be included in a three-dimensional image information management table (e.g., the three-dimensional image information management table illustrated in FIG. 4).

The second display area 215 of the text image display screen 220 further displays the capture-generated image 237 and the three-dimensional image information 222. The capture-generated image 237 is a capture-generated image (stored in the image management server 40) captured at the date and time closest to the timestamp of audio capture 216 associated with the selected speech text 217. In an initial state, the three-dimensional image information 222 has the same image capturing position and the same angle of view as the capture-generated image 237. Since the three-dimensional image information 222 is a wide-view image, the user can change the angle-of-view information of the three-dimensional image information 222.

Further, in order to view a past capture-generated image of a desired article, the user operates the three-dimensional image information 222 to designate an angle of view at which the desired article (point of view) is to be displayed. For example, the user designates an angle of view for enlarging the three-dimensional image information 223 of the table. Thus, the three-dimensional image information 223 of the table is used to update a tacit knowledge model. In response to the user pressing the information display button 225, the message 227 illustrated in FIG. 15 is displayed in a pop-up window.

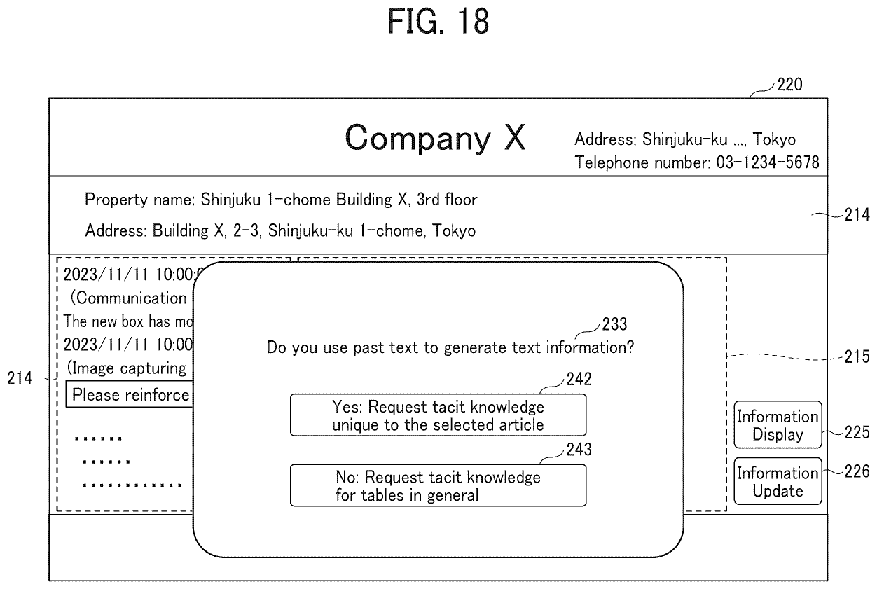

The information display button 225 is used to display past text and a past capture-generated image and also display text information generated based on tacit knowledge comments, as described below. In response to the information display button 225 being pressed, a message 233 illustrated in FIG. 18 is also displayed.

FIG. 15 illustrates the message 227 displayed in a pop-up window on the text image display screen 220. The message 227 prompts the user to determine whether to use past text and a past capture-generated image for model update. The user presses the “YES” button 228 to update the first tacit knowledge model 4004A using past text and a past capture-generated image, and presses the “NO” button 229 to update the second tacit knowledge model 4004B without using past text and a past capture-generated image. In one example, the determination is made based on whether the input information 241 is specific to the designated article or is common to articles of the same category in general.

In FIG. 15, the user presses the information update button 226. Accordingly, a request to update a tacit knowledge model is transmitted to the image management server 40. The message 227 is displayed to inquire whether the first tacit knowledge model 4004A is to be updated or the second tacit knowledge model 4004B is to be updated.

### Inference Phase (Text Information Generation)

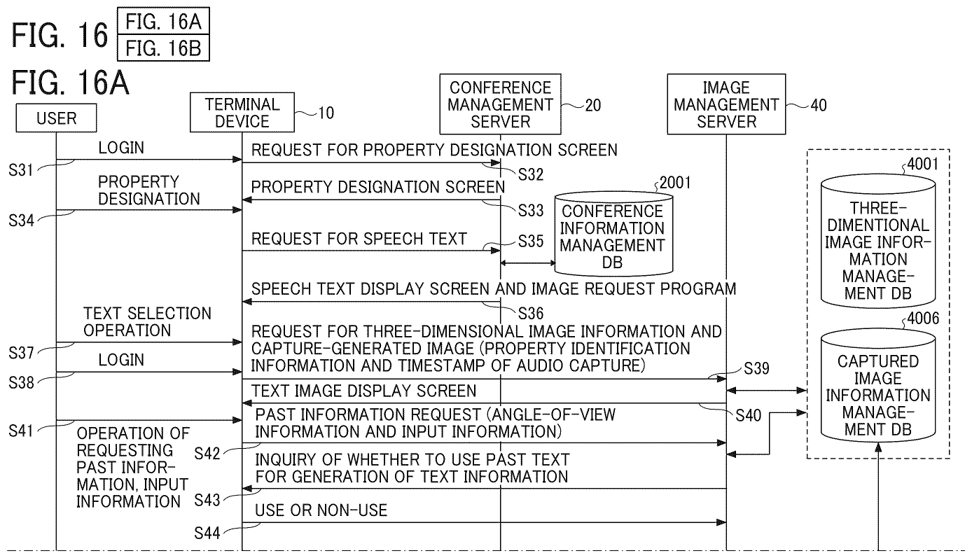

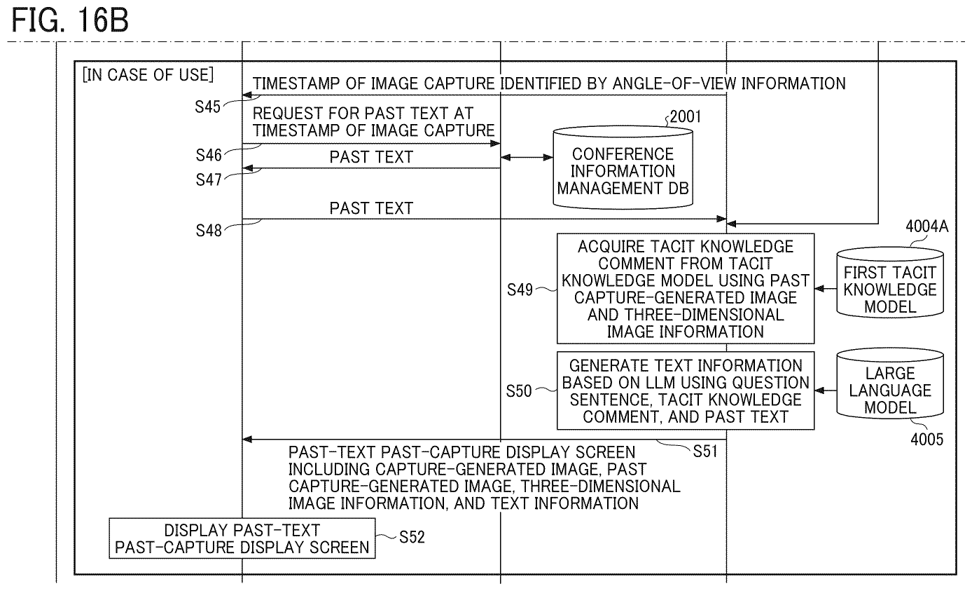

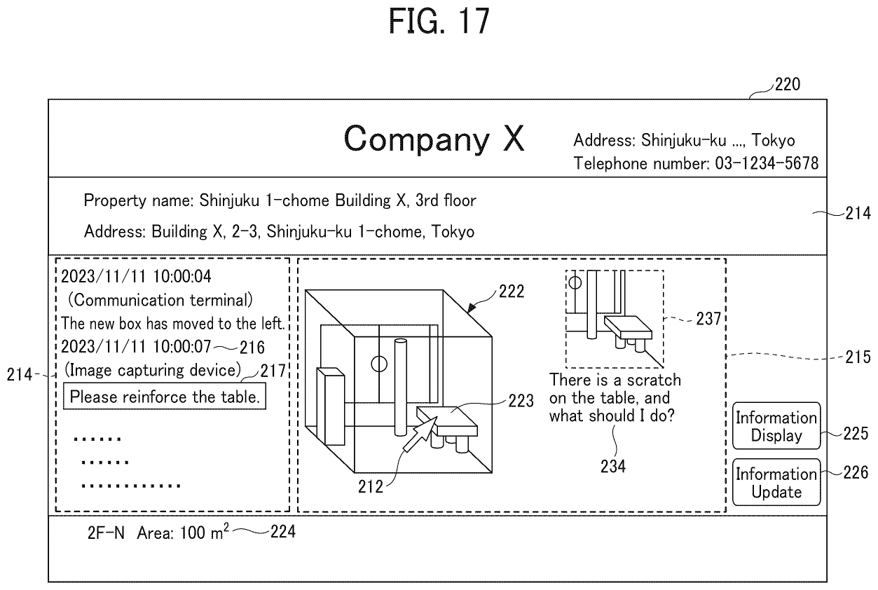

Next, a text information generation process using the first tacit knowledge model 4004A will be described with reference to FIG. 16. FIG. 16 is a sequence diagram illustrating an example of a text information generation process using the first tacit knowledge model 4004A. In the description of FIG. 16, differences from FIG. 10 may be described. The processing of steps S31 to S42 may be similar to that of steps S1 to S12 in FIG. 10. Note that, in step S41, the user enters a question sentence 234 regarding an article and then presses the information display button 225 (see FIG. 17).

S43: The transmission/reception unit 41 of the image management server 40 receives the past information request (a notification that the information display button 225 has been pressed) in which the angle-of-view information and the input information are designated. The determination unit 48 determines to inquire of the user in order to determine which of the first tacit knowledge model 4004A and the second tacit knowledge model 4004B is to be used to generate text information. The transmission/reception unit 41 inquires of the terminal device 10 whether past text is to be used for generation of text information.

S44: The transmission/reception unit 11 of the terminal device 10 receives the inquiry, and the display control unit 13 causes the message 233 as to whether to use past text for generation of text information (see FIG. 18) to be displayed on the text image display screen 220. The user confirms the message 233 and presses a “YES” (i.e., use) button 242 or a “NO” (i.e., non-use) button 243. Criteria for the determination will be described below. The input reception unit 12 accepts the pressing of the “YES” button 242 or the “NO” button 243. The transmission/reception unit 11 of the terminal device 10 transmits the selected option (use or non-use) to the image management server 40.

S45: Since the transmission/reception unit 41 of the image management server 40 receives the selected option (use or non-use), the determination unit 48 determines whether past text is to be used, based on the selected option (use or non-use). FIG. 16 illustrates a case where past text is to be used. The transmission/reception unit 41 of the image management server 40 transmits the timestamp of image capture identified by the angle-of-view information to the terminal device 10 in order to acquire past text.

The processing of steps S46 to S48 may be similar to that of steps S16 to S18 in FIG. 10.

S48: The transmission/reception unit 41 of the image management server 40 receives the past text as a response to the request in step S45. The storing/reading unit 49 stores the past text in the captured image information management DB 4006 in association with the timestamp of image capture identified in step S42. Accordingly, the speech text is associated with the capture-generated image.

S49: Subsequently, the processing unit 47 requests the text information generation unit 45 to generate text information. Since it is determined that past text is to be used to generate text information, the text information generation unit 45 acquires a tacit knowledge comment corresponding to the three-dimensional image information of the article and the past capture-generated image identified in step S42 from the first tacit knowledge model 4004A. The first tacit knowledge model 4004A can extract features of the three-dimensional image information of the article and the past capture-generated image and identify at least one of past text and input information corresponding to the features. The first tacit knowledge model 4004A extracts at least one of the past text and the input information as a tacit knowledge comment.

S50: Subsequently, the text information generation unit 45 acquires text information created by the large language model 4005 using the tacit knowledge comment, the input information (question sentence), and the past text. The large language model 4005 can generate more detailed text information using the tacit knowledge comment, the input information (question sentence), and the past text. The text information generation unit 45 may convert voice information included in the input information (question sentence) into character information. The text information generated by the text information generation unit 45 may be either voice information or character information.

The text information generation unit 45 may generate text information without using any past text and input information (question sentence) at all. Alternatively, the text information generation unit 45 may generate a fixed question within the information processing system 100 in advance and use the fixed question to generate text information. In this case, the question sentence is invisible to the user. Alternatively, the text information generation unit 45 may generate fixed questions within the information processing system 100 in advance, which are then displayed on the display unit to prompt the user to select any of the fixed questions, and use the selected question.

As described above, past text and input information are optional. However, using past text and input information to generate text information from the large language model 4005 provides more detailed information related to an article. For example, when past text or input information includes the severity of a scratch on an article, text information including appropriate measures to be taken in accordance with the severity of the scratch can be generated.

S51: The processing unit 47 requests the screen generation unit 42 to generate a screen displaying the capture-generated image displayed on the screen in step S40, the three-dimensional image information with the angle of view received in step S42, the past capture-generated image identified in step S42, and the text information in association with one another. The screen generation unit 42 generates a screen corresponding to the second display area 215 for displaying the three-dimensional image information, the capture-generated image, the past capture-generated image, and the generated text information.

The screen generation unit 42 may perform an update process for adding only the text information to the screen corresponding to the second display area 215. The transmission/reception unit 41 of the image management server 40 transmits screen information of the screen corresponding to the second display area 215 to the terminal device 10.

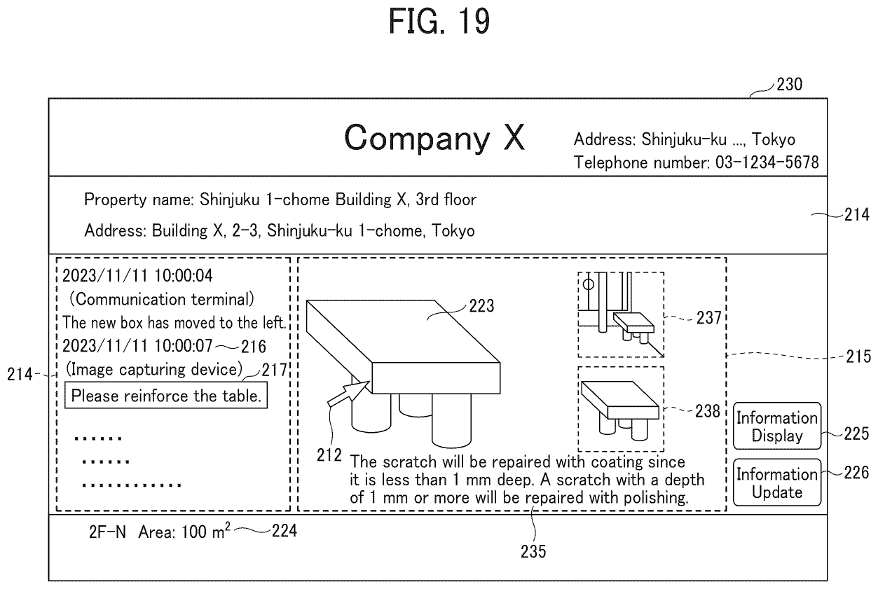

S52: The transmission/reception unit 11 of the terminal device 10 receives the screen information of the screen corresponding to the second display area 215 transmitted from the image management server 40. The display control unit 13 of the terminal device 10 displays a past-text past-capture display screen 230 (see FIG. 19) including the first display area 214 and the second display area 215. Alternatively, the conversion unit 15 converts the received text information into voice information, and the audio control unit 14 controls the speaker 109a to reproduce the converted text information. When the received text information is voice information, the text information is reproduced by the speaker 109a, or the conversion unit 15 converts the received text information into character information and the display 106a displays the converted text information.

In FIG. 16, the image management server 40 acquires the past text from the terminal device 10. Alternatively, as in FIG. 20, the image management server 40 may acquire the past text from the conference management server 20.

### Example Screens in Inference Phase

Screens to be displayed on the terminal device 10 in the inference phase are similar to those illustrated in FIGS. 12 to 14. On the text image display screen 220 illustrated in FIG. 14, the user enters input information (a question sentence) and presses the information display button 225.

FIG. 17 illustrates an example of a text image display screen 220 in the inference phase (an example of a first display screen). The text image display screen 220 includes the first display area 214 and the second display area 215. The text image display screen 220 illustrated in FIG. 17 has substantially the same configuration as the text image display screen 220 illustrated in FIG. 14, except that the user enters a question sentence 234 as input information. The second display area 215 displays the input information (the question sentence 234) in association with the three-dimensional image information 223 of the table. For example, the question sentence 234 illustrated in FIG. 17 states, “There is a scratch on the table, and what should I do?” The user presses the information display button 225 to make a request to generate text information using a tacit knowledge model, together with the question sentence 234.

FIG. 18 illustrates the message 233 displayed in a pop-up window on the text image display screen 220. The message 233 prompts the user to determine whether to use past text for generation of text information. The user presses the “YES” button 242 to generate text information using past text, and presses the “NO” button 243 to generate text information without using past text.

Criteria for determination by the user will be described. As described above, the first tacit knowledge model 4004A and the second tacit knowledge model 4004B have the following differences.
The first tacit knowledge model 4004A can generate text information specialized for expert knowledge and a specific article.
The second tacit knowledge model 4004B can generate general-purpose text information applicable to expert knowledge and articles of the same kind (or the same category) in general.

For example, the specific article is a centrifugal chiller used by a customer. In this case, the inspection history and the know-how of the article, which is owned by the customer, have been accumulated. The user determines to use the accumulated information and the first tacit knowledge model 4004A to generate accurate text information (e.g., an answer) specialized for the specific article.

Although such accurate information is not found for articles of the same type in general (refrigerators in the category of centrifugal chillers), there is expertise related to the general centrifugal chillers. In this case, accordingly, it is considered that the user uses the second tacit knowledge model 4004B to generate general-purpose text information (e.g., an answer) applicable to articles of the same kind in general. As described above, the user can determine whether to use past text to generate text information, based on the degree of detail of information to be used.

The determination unit 48, rather than the user, may determine whether to use past text to generate text information, automatically (without confirming with the user) or semi-automatically (by recommending to the user and requesting confirmation). For example, when a question sentence included in input information (voice and/or characters) is related to an article, the determination unit 48 determines to use the first tacit knowledge model 4004A because the second tacit knowledge model 4004B may fail to generate appropriate text information.

The number of types of tacit knowledge models is not limited to two and may be three or more, and the user may select a desired tacit knowledge model.

FIG. 19 illustrates an example of text information displayed on the past-text past-capture display screen 230. The past-text past-capture display screen 230 includes the first display area 214 and the second display area 215. In FIG. 19, the three-dimensional image information 223 of the table is displayed in order for the user to request a tacit knowledge comment regarding the table. The angle-of-view information of the three-dimensional image information 223 of the table is transmitted to the image management server 40, and the timestamp of image capture closest to the timestamp of image capture associated with the transmitted angle-of-view information is identified. In the image management server 40, the identified timestamp of image capture is associated with a past capture-generated image 238.

Text information 235 states, “The scratch will be repaired with coating since it is less than 1 mm deep. A scratch with a depth of 1 mm or more will be repaired with polishing”. The text information 235 is displayed in the second display area 215 in association with the three-dimensional image information 223 of the table. The text information 235 is generated by the large language model 4005, based on the tacit knowledge comment, the past text, and the question sentence. For example, in response to detection of a scratch in a past capture-generated image of an article, the first tacit knowledge model 4004A outputs a tacit knowledge comment related to the scratch on the article. The tacit knowledge comment, the question sentence related to the scratch, and past text related to the state of the scratch are input to the large language model 4005, and thus text information appropriate for a question related to the scratch can be generated.

Effects of generating text information using a past capture-generated image as in the present embodiment will be described.

1. Comparative Example 1 (Case of Using General Large Language Model)

Question sentence: The user asks a question, “How should I repair a crack?”

Tacit knowledge comment: You can use tape or filler to repair it.

2. Comparative Example 2 (Case of Learning from Three-Dimensional Image Information)

Learning Phase

Training data: While displaying a three-dimensional image, the user asks a question, “How should I repair a crack?”

Input information: Please use tape for a large width crack and filler for a small width crack.

Inference Phase

Input image: Three-dimensional image information

Question sentence: “How should I repair a crack?”

Tacit knowledge comment: There are a large width crack and a small width crack, so the use of tape is recommended for the large width crack and the use of filler is recommended for the small width crack.

3. Present Embodiment (Three-Dimensional Image Information, Past Capture-Generated Image, and Past Text)

Learning Phase

Input image: Three-dimensional image information and a past capture-generated image

Past text: When tape is applied to the corner, a crack may occur.

Inference Phase

Input image: Three-dimensional image information and a past capture-generated image

Question sentence: “How should I repair a crack?”

Tacit knowledge comment: There are a large width crack and a small width crack, so the use of tape is recommended for the large width crack and the use of filler is recommended for the small width crack. Please be careful when applying tape to the corner, as a crack may occur.

That is, an effect obtained by learning from the past text is the comment, stating “Please be careful when applying tape to the corner, as a crack may occur”.

4. Present Embodiment (Three-Dimensional Image Information, Past Capture-Generated Image, Past Text, and Input Information)

Learning Phase

Input image: Three-dimensional image information and a past capture-generated image

Past text: When tape is applied to the corner, a crack may occur.

Input information: A large width crack extends across the corner.

Inference Phase

Input image: Three-dimensional image information and a past capture-generated image

Question sentence: “How should I repair a crack?”

Tacit knowledge comment: There are a large width crack and a small width crack, so the use of tape is recommended for the large width crack and the use of filler is recommended for the small width crack. Please be careful when applying tape to the corner, as a crack may occur.

That is, an effect obtained by learning from the past text is the comment, stating “Please be careful when applying tape to the corner, as a crack may occur”.

### Example in which Image Management Server Acquires Past Text from Conference Management Server

In FIGS. 10 and 16, the image management server 40 acquires, from the terminal device 10, the past text acquired by the terminal device 10 from the conference management server 20. However, the image management server 40 may acquire the past text directly from the conference management server 20.

FIG. 20 is a sequence diagram illustrating an example of a process in which the image management server 40 updates a model through communication with the conference management server 20. While differences from FIG. 10 will be described with reference to FIG. 20, the sequence diagram of FIG. 16 is also modified in a similar manner. The processing of steps S1 to S14 may be similar to that in FIG. 10.

S21: Since the transmission/reception unit 41 of the image management server 40 receives the selected option (use or non-use), the determination unit 48 determines whether past text is to be used, based on the selected option (use or non-use). FIG. 20 illustrates a case where past text is to be used. By calling an API of the conference management server 20, the transmission/reception unit 41 of the image management server 40 transmits a request for past text for which the timestamp of image capture identified by the angle-of-view information is designated to the conference management server 20 in order to acquire the past text.

S22: The transmission/reception unit 21 of the conference management server 20 receives the request for past text. The storing/reading unit 29 searches the conference information management DB 2001 for the timestamp of audio capture by using the received timestamp of image capture. The storing/reading unit 29 acquires, from the conference information management DB 2001, the speech text at the corresponding timestamp (image capturing device) and the speech text at the corresponding timestamp (communication terminal) associated with a timestamp of audio capture that is the same as or the closest to the timestamp of image capture. The transmission/reception unit 21 transmits the acquired past text to the image management server 40.

The subsequent processing may be similar to that in FIG. 10. In FIG. 20, the process in which the image management server 40 acquires past text from the conference management server 20 is described using, as an example, the sequence diagram for model update. The same applies to the case of text information generation illustrated in FIG. 16.

### Case of Using Second Tacit Knowledge Model for Learning or Inference

### Learning Phase (Model Update)

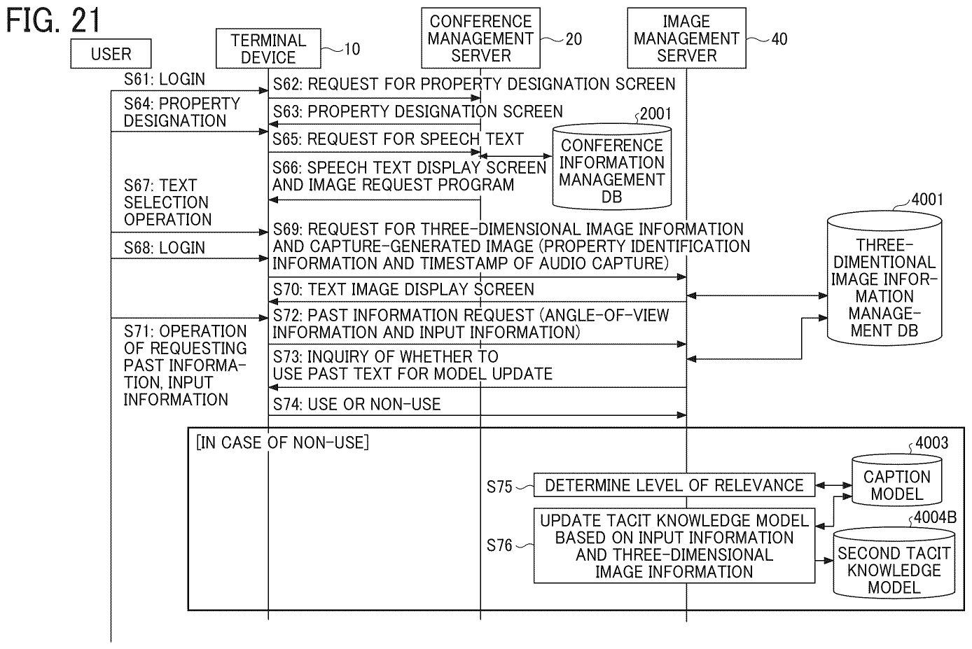

Next, a model update process in which the second tacit knowledge model 4004B is trained on data will be described with reference to FIG. 21. FIG. 21 is a sequence diagram illustrating an example of the model update process. In the description of FIG. 21, differences from FIG. 10 will be described. The processing of steps S61 to S74 may be similar to that of steps S1 to S14 in FIG. 10.

S75: Since the transmission/reception unit 41 of the image management server 40 receives the selected option (use or non-use), the determination unit 48 determines whether past text is to be used, based on the selected option (use or non-use). FIG. 21 illustrates a case where past text is not to be used. Since no past text is to be used, the process in which the image management server 40 acquires past text from the conference management server 20 is not performed. The processing for determining a level of relevance may be similar to that in FIG. 10.

S76: The update unit 46 updates the caption model 4003 by associating a comment determined to have a high level of relevance in step S75, as a caption comment, with the model ID. The update unit 46 also updates the second tacit knowledge model 4004B using, as training data, a comment determined to have a low level of relevance in step S75 and three-dimensional image information (identified in step S72) of an article related to the comment. That is, the correspondence between the three-dimensional image information of the article and the comment is learned (past text is not learned). Features of the three-dimensional image information of the article are extracted using some feature extraction models suitable for images, such as CNN models. The features represent, for example, objects that appear in an image and positions of the objects appearing in the image, or operations that are being performed in the image. Thus, the second tacit knowledge model 4004B can learn the correspondence between the features of the three-dimensional image information of the article and the comment.

Screens to be displayed on the terminal device 10 in the learning phase may be similar to those illustrated in FIGS. 12 to 15.

### Inference Phase (Text Information Generation)

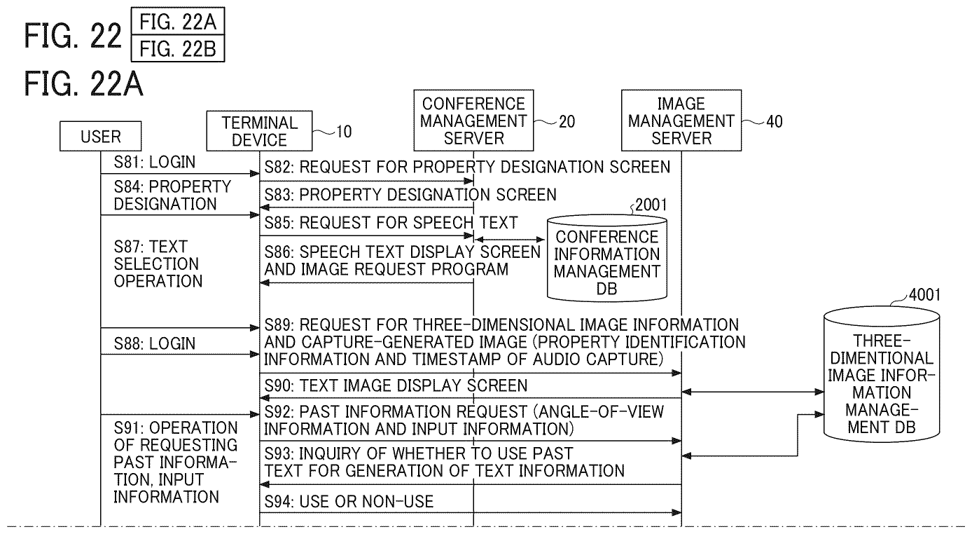

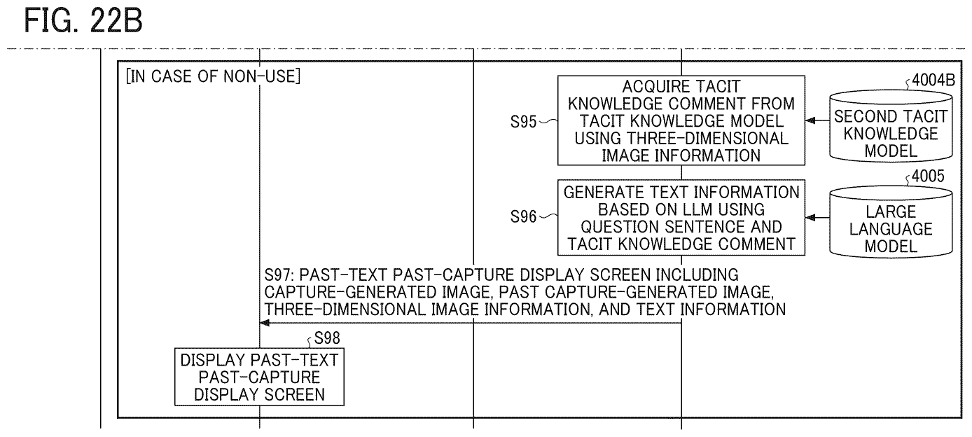

Next, a text information generation process using the second tacit knowledge model 4004B will be described with reference to FIG. 22. FIG. 22 is a sequence diagram illustrating an example of a text information generation process using the second tacit knowledge model 4004B. In the description of FIG. 22, differences from FIG. 16 may be described. The processing of steps S81 to S94 may be similar to that of steps S31 to S44 in FIG. 16.

S95: Since the transmission/reception unit 41 of the image management server 40 receives the selected option (use or non-use), the determination unit 48 determines whether past text is to be used, based on the selected option (use or non-use). FIG. 22 illustrates a case where past text is not to be used. Since no past text is to be used, the process in which the image management server 40 acquires past text from the conference management server 20 is not performed.

Subsequently, the processing unit 47 requests the text information generation unit 45 to generate text information. The text information generation unit 45 acquires a tacit knowledge comment corresponding to the three-dimensional image information of the article from the second tacit knowledge model 4004B. The second tacit knowledge model 4004B can extract features of the three-dimensional image information of the article and identify a comment corresponding to the features (without past text). The second tacit knowledge model 4004B extracts the comment as a tacit knowledge comment.

S96: Subsequently, the text information generation unit 45 acquires text information created by the large language model 4005 using the tacit knowledge comment and the input information (question sentence). The large language model 4005 can generate more detailed text information using the tacit knowledge comment and the input information (question sentence). The text information generation unit 45 may convert voice information included in the input information into character information. The text information generated by the text information generation unit 45 may be either voice information or character information.

The text information generation unit 45 may generate text information without using any question sentences. Alternatively, the text information generation unit 45 may generate a fixed question within the information processing system 100 in advance and use the fixed question to generate text information. In this case, the question sentence is invisible to the user. Alternatively, the text information generation unit 45 may generate fixed questions within the information processing system 100 in advance, which are then displayed on the display unit to prompt the user to select any of the fixed questions, and use the selected question.

The subsequent processing may be similar to that in FIG. 16.

### Example Screens

Of the screens to be displayed on the terminal device 10 in the inference phase, the property designation screen 200 may be similar to that illustrated in FIG. 12, and the speech text display screen 210 may be similar to that illustrated in FIG. 13. The text image display screen 220 is similar to that illustrated in FIGS. 17 and 18. In the process illustrated in FIG. 22, however, text information different from the text information 235 on the past-text past-capture display screen 230 illustrated in FIG. 19 is generated.

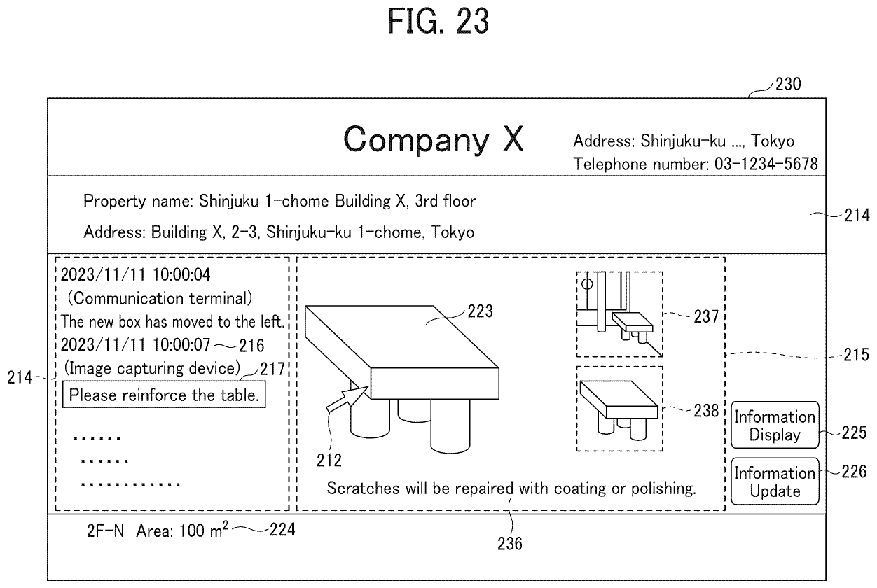

FIG. 23 illustrates a past-text past-capture display screen 230 including text information 236 generated based on the second tacit knowledge model 4004B. The text information 236 states, “Scratches will be repaired with coating or polishing”. The text information 236 is displayed in the second display area 215 in association with the three-dimensional image information 223 of the table. The text information 236 is generated by the large language model 4005, based on the tacit knowledge comment generated by the second tacit knowledge model 4004B and the input information (question sentence). Thus, even when the article has a scratch, past text or a past capture-generated image is not reflected in the tacit knowledge comment. In addition, the large language model 4005 does not use past text to generate text information.

Accordingly, when the text information 236 illustrated in FIG. 23 is compared with the text information 235 illustrated in FIG. 19, the text information 236 is general text information regarding scratches on a table and is less detailed than the text information 235. However, the text information 236 has higher versatility with respect to scratches on a table.

### Multimodal Models

Some examples of combinations of input information and tacit knowledge comments will be described. The model described above is assumed to be a large language model. However, the present embodiment may use a multimodal model that receives a plurality of data formats (e.g., image, text, and gesture) as input and outputs a predetermined data format.

Case where the input information is a character string and content other than text information is generated as a tacit knowledge comment

A character string is input, and an image is generated. A character string is input, and a moving image is generated. A character string is input, and a voice is generated. A character string is input, and a 3D model is generated.

Case where the input information includes a character string and non-character string information and text information is generated as a tacit knowledge comment

An image and a character string are input, and text information is generated. A 3D model and a character string are input, and text information is generated. A voice and a character string are input, and text information is generated.

Case where the input information includes a character string and non-character string information and content other than text information is generated as a tacit knowledge comment

An image and a character string are input, and an image is generated. A moving image and a character string are input, and a moving image is generated. A 3D model and a character string are input, and a 3D model is generated. A voice and a character string are input, and a voice is generated. The present embodiment enables a user to selectively use the first tacit knowledge model 4004A, which is trained on past text and a past capture-generated image, and the second tacit knowledge model 4004B, which is trained without using past text and a past capture-generated image. That is, the image management server 40 can generate detailed text information using past text and a tacit knowledge comment output from the first tacit knowledge model 4004A to which accumulated past capture-generated images are input. In contrast, the image management server 40 can generate text information having high versatility for articles of the same category in general by using the second tacit knowledge model 4004B.

### Second Embodiment

A second embodiment of the present disclosure describes tacit knowledge model update and inference in a case where a user logs in to the image management server 40. It is not clear whether a user who has directly logged in to the image management server 40 is authorized to log in to the conference management server 20. The first tacit knowledge model 4004A is updated using past text and a past capture-generated image. Thus, in a case where a user unauthorized to log in to the conference management server 20 logs in to the image management server 40, it is not preferable to give permission to such a user to use the first tacit knowledge model 4004A. In the present embodiment, accordingly, in a case where a user directly logs in to the image management server 40, the user is granted permission to update only the second tacit knowledge model 4004B and generate text information.

In the present embodiment, reference is also made to the hardware configuration diagram of FIG. 2 and the functional block diagram of FIG. 3, which have been described in the first embodiment.

### Operations or Processes

### Learning Phase (Model Update)

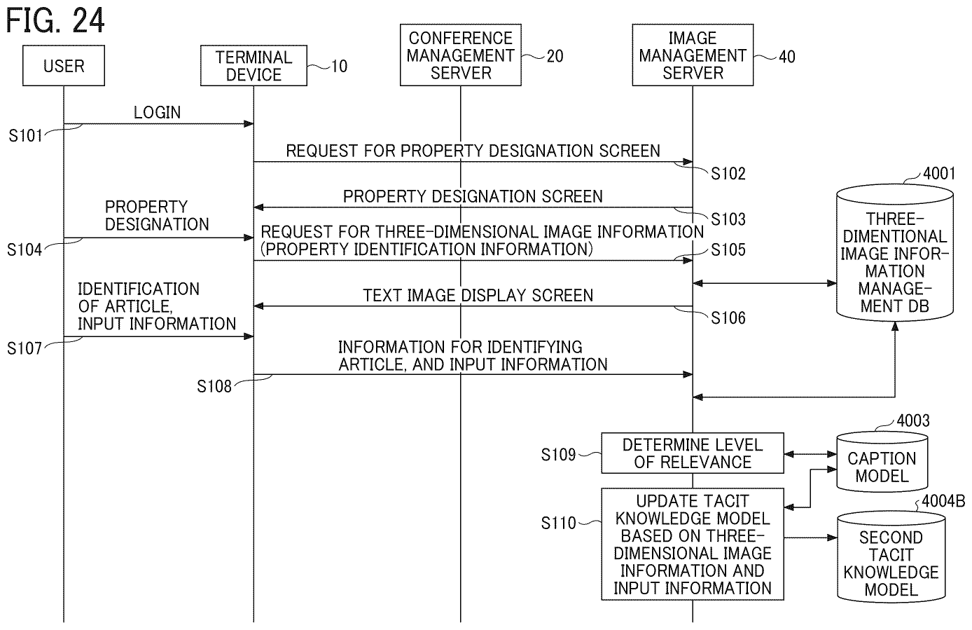

A model update process in which the second tacit knowledge model 4004B learns from data will be described with reference to FIG. 24. FIG. 24 is a sequence diagram illustrating an example of the model update process.

S101: A user inputs a login operation to the terminal device 10. This login is to log in to the image management server 40. The input reception unit 12 of the terminal device 10 accepts the login operation. Any existing method may be used to perform the login. The following description is given on the assumption that the login is successful.

S102: In response to a successful login, the transmission/reception unit 11 of the terminal device 10 transmits a request for the property designation screen 200 to the image management server 40.

S103: The transmission/reception unit 41 of the image management server 40 receives the request for the property designation screen 200. The screen generation unit 42 generates the property designation screen 200, and the transmission/reception unit 41 transmits screen information of the property designation screen 200 to the terminal device 10.

S104: The transmission/reception unit 11 of the terminal device 10 receives the screen information of the property designation screen 200. The display control unit 13 displays the property designation screen 200 (see FIG. 12). The user enters property identification information (e.g., V0001) on the displayed property designation screen 200. The input reception unit 12 of the terminal device 10 receives the property identification information.

S105: The transmission/reception unit 11 of the terminal device 10 transmits a request for three-dimensional image information of the property for which the property identification information is designated to the image management server 40. Since the terminal device 10 has not logged in to the conference management server 20, the speech text display screen 210 illustrated in FIG. 13 is not displayed.

S106: The transmission/reception unit 41 of the image management server 40 receives the request, and the storing/reading unit 49 searches the three-dimensional image information management DB 4001 using the property identification information. The storing/reading unit 49 acquires three-dimensional image information of each article. The screen generation unit 42 generates a screen corresponding to the second display area 215 for displaying three-dimensional image information of each article. The transmission/reception unit 41 transmits the three-dimensional image information corresponding to the screen corresponding to the second display area 215 to the terminal device 10. The three-dimensional image information of each article is three-dimensional image information of articles placed in the property identified by the property identification information. Since the articles are represented by 3D model shape information, the terminal device 10 projects three-dimensional model shapes of the articles into two dimensions to generate a planar image. The user can view any article while changing the point of view.

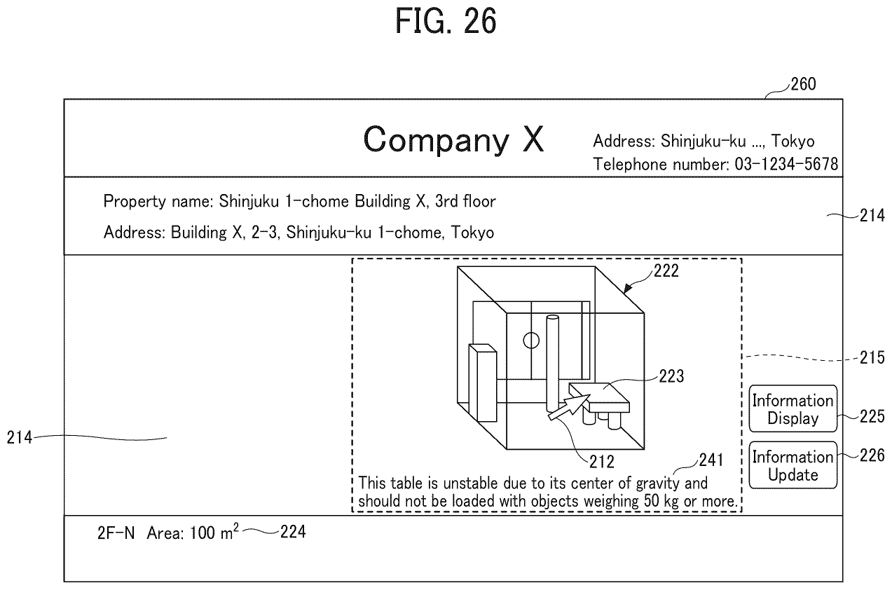

S107: The transmission/reception unit 11 of the terminal device 10 receives the screen information of the screen corresponding to the second display area 215, and the display control unit 13 displays a property display screen 260 including the second display area 215 (see FIG. 26). In the present embodiment, the terminal device 10 has not logged in to the conference management server 20. Thus, speech text stored in the conference management server 20 is not displayed. The screen generation unit 42 may use the captured image information management DB 4006, which is managed by the image management server 40, to display speech text. Subsequently, the user identifies any article from the three-dimensional image information of the property. When the user identifies an article, the user can request a model update. The input reception unit 12 of the terminal device 10 accepts the operation of identifying the article. The article may be identified by, for example, the coordinates of a position clicked by the user, or a model ID may be identified using the coordinates.

The user inputs comments related to the article, such as the comments (character information or voice) described with reference to FIGS. 8A, 8B, 9A, and 9B, to the terminal device 10. The comments may be referred to as input information. The comments may be tacit knowledge comments. The comments may include a caption comment describing the article.

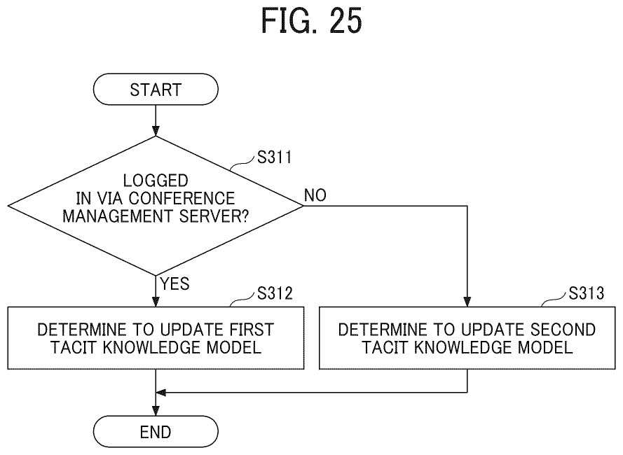

S108: In response to the user pressing the information update button 226, the transmission/reception unit 11 of the terminal device 10 transmits a notification that the information update button 226 has been pressed (a model update request), information for identifying the article, and the input information to the image management server 40. The transmission/reception unit 41 of the image management server 40 receives the notification, the information for identifying the article, and the input information. The determination unit 48 determines which of the first tacit knowledge model 4004A and the second tacit knowledge model 4004B is to be updated. Since the determination unit 48 determines that the login in step S101 is not a login using the image request program distributed from the conference management server 20 (i.e., the login in step S101 is a direct login to the image management server 40), the determination unit 48 determines to update the second tacit knowledge model 4004B. The determination of step S108 will be described with reference to FIG. 25.

The processing of steps S109 and S110 may be similar to that of steps S75 and S76 in FIG. 21. In other words, the second tacit knowledge model 4004B is updated.

FIG. 25 is a flowchart illustrating a process in which the determination unit 48 determines whether to update the first tacit knowledge model 4004A or the second tacit knowledge model 4004B. In FIG. 25, the determination unit 48 determines whether a login to the image management server 40 has been performed via the conference management server 20 (step S311). The determination unit 48 can determine whether a login to the image management server 40 has been performed via the conference management server 20, based on whether the login is a login using the image request program distributed from the conference management server 20.

If the determination in step S311 is “YES”, the determination unit 48 determines to update the first tacit knowledge model 4004A (step S312).

If the determination in step S311 is “NO”, the determination unit 48 determines to update the second tacit knowledge model 4004B (step S313).

While model updating is illustrated as an example in FIG. 25, the illustrated process is also applicable to selection of a model to be used to generate text information.

### Example Screens

The property designation screen 200 to be displayed on the terminal device 10 in the learning phase may be similar to that illustrated in FIG. 12. The speech text display screen 210 illustrated in FIG. 13, which is a screen generated by the conference management server 20, is not displayed. The property display screen 260 according to the present embodiment will be described with reference to FIG. 26.

FIG. 26 illustrates the property display screen 260 according to the present embodiment. The property display screen 260 includes the second display area 215. As compared with FIG. 14, speech text is not displayed in the first display area 214 in FIG. 26. This is because since the terminal device 10 has directly logged in to the image management server 40, speech text managed by the conference management server 20 is not displayed. The second display area 215 does not display the capture-generated image 237. This is because no speech text is selected.

### Inference Phase (Text Information Generation)

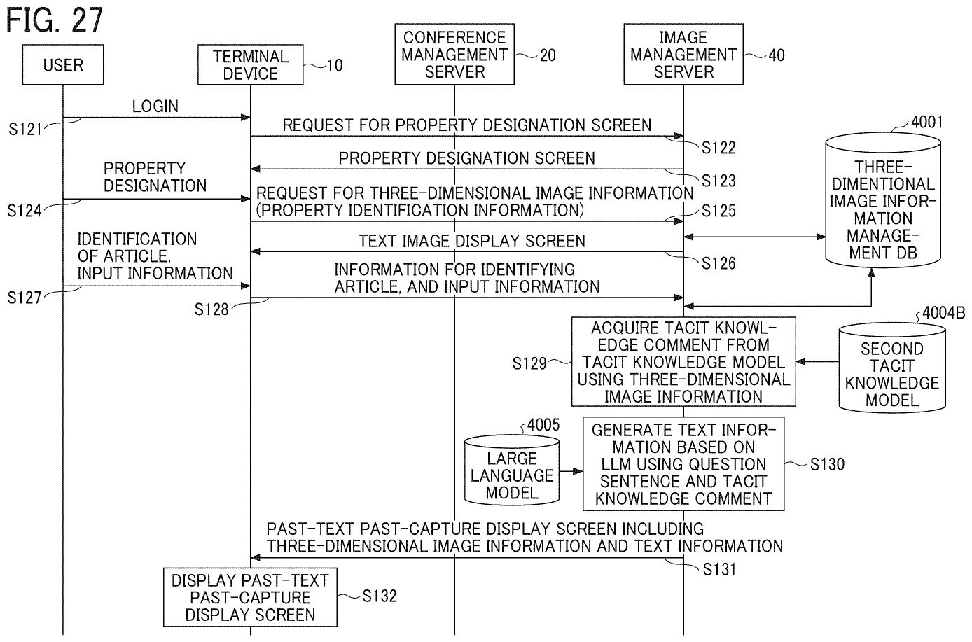

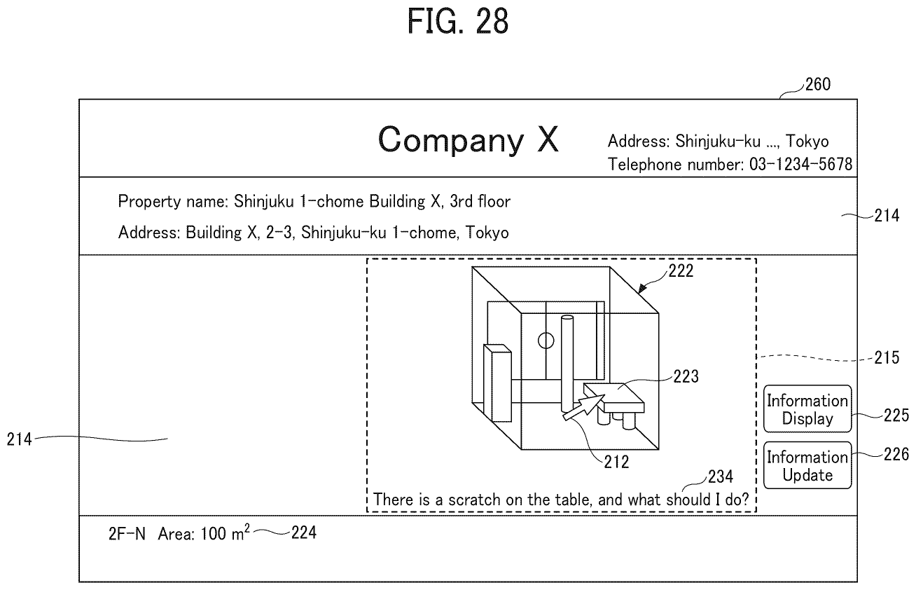

Next, a text information generation process using the second tacit knowledge model 4004B will be described with reference to FIG. 27. FIG. 27 is a sequence diagram illustrating an example of the text information generation process using the second tacit knowledge model 4004B when the terminal device 10 directly logs in to the image management server 40. In the description of FIG. 27, differences from FIG. 24 may be described. The processing of steps S121 to S128 may be similar to that of steps S101 to S108 in FIG. 24. Note that, in step S127, the user enters a question sentence regarding an article (see FIG. 28).

S129: The transmission/reception unit 11 of the terminal device 10 transmits a notification that the information display button 225 has been pressed, information for identifying the article, and the input information (question sentence) to the image management server 40. The transmission/reception unit 41 of the image management server 40 receives the notification, the information for identifying the article, and the input information. The determination unit 48 determines which of the first tacit knowledge model 4004A and the second tacit knowledge model 4004B is to be updated. Since the determination unit 48 determines that the login in step S121 is not a login using the image request program distributed from the conference management server 20 (i.e., the login in step S121 is a direct login to the image management server 40), the determination unit 48 determines to generate text information using the second tacit knowledge model 4004B.

The subsequent processing may be similar to that in FIG. 22. In other words, text information is generated using the second tacit knowledge model 4004B and the large language model 4005. In step S131, the processing unit 47 associates the information for identifying the article and the input information, received at S128, and requests the image generation unit 42 to display the associated information. The image generation unit 42 generates a screen of the second display area 215, which displays the three-dimensional image information and the generated text information. In step S132, the second display area 215 displays the three-dimensional image information and the text information, but none of the capture-generated image 237 and the past capture-generated image 238.

### Example Screens

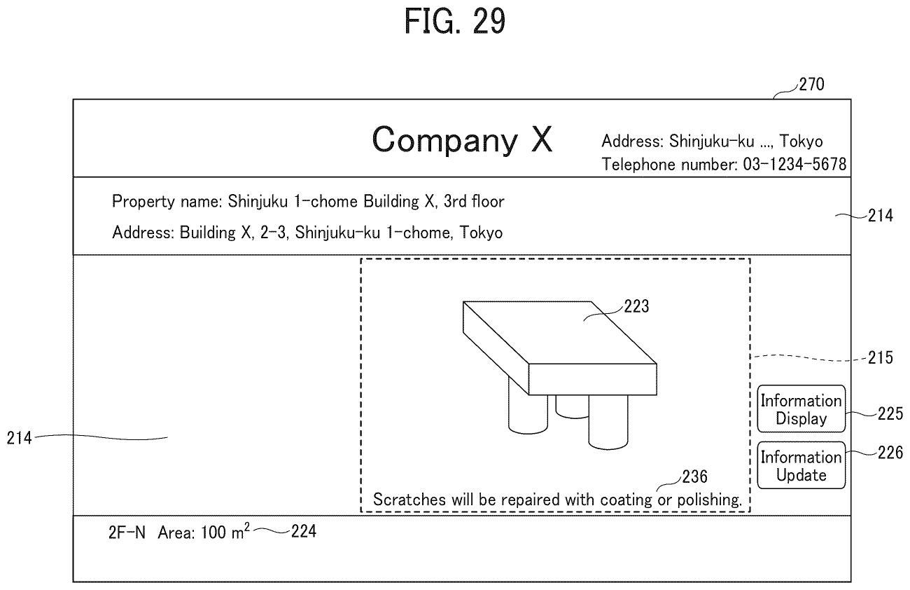

The property designation screen 200 to be displayed on the terminal device 10 in the inference phase may be similar to that illustrated in FIG. 12. The speech text display screen 210 illustrated in FIG. 13, which is a screen generated by the conference management server 20, is not displayed. A property display screen 260 in the inference phase is as illustrated in FIG. 28, and a past-text past-capture display screen 270 in the inference phase is as illustrated in FIG. 29.

FIG. 28 illustrates the property display screen 260 in a case where the terminal device 10 directly logs in to the image management server 40 (an example of a second display screen). As compared with FIG. 17, speech text is not displayed in FIG. 28. This is because since the terminal device 10 has directly logged in to the image management server 40, speech text managed by the conference management server 20 is not displayed. The second display area 215 does not display the capture-generated image 237. This is because no speech text is selected and thus the capture-generated image 237 is not identified.

FIG. 29 illustrates the past-text past-capture display screen 270 according to the present embodiment. As compared with FIG. 23, speech text is not displayed in FIG. 29. This is because the terminal device 10 has directly logged in to the image management server 40. In addition to the capture-generated image 237 being not displayed, the second display area 215 does not display the past capture-generated image 238. T This is because, even when the angle-of-view information is designated using the three-dimensional image information 223 of the table on the property display screen 260 illustrated in FIG. 28, it is not clear which of the past capture-generated images in the captured image information management DB 4006 is to be specified. However, the past capture-generated image 238 may be displayed.

In the present embodiment, furthermore, text information 236 similar to the text information 236 illustrated in FIG. 23 is displayed since the text information 236 is generated based on the second tacit knowledge model 4004B.

In the present embodiment, in a case where a user has directly logged in to the image management server 40, providing text information generated using the first tacit knowledge model 4004A, which is trained on a capture-generated image and speech text, to the user can be restricted. Even in this case, the image management server 40 can provide text information generated using the second tacit knowledge model 4004B, which is not trained on a capture-generated image and speech text, to the user. In a case where the user has logged in to the image management server 40 via the conference management server 20, text information generated using the first tacit knowledge model 4004A, which is trained on a capture-generated image and speech text, can be provided to the user.

### Third Embodiment

A third embodiment of the present disclosure describes an information processing system 100 in which each of two terminal devices generates text information.

### Example of System Configuration

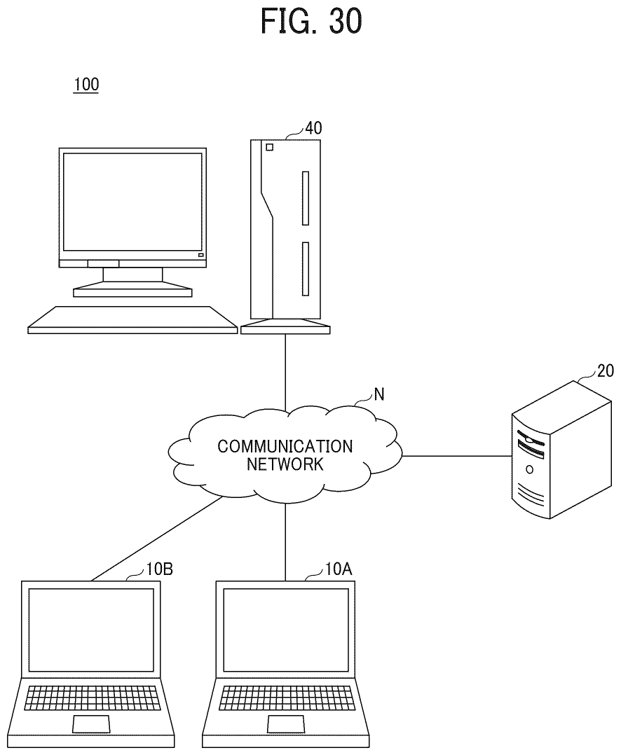

FIG. 30 is a diagram illustrating a general arrangement of the information processing system 100 according to the present embodiment. In the description of FIG. 30, differences from FIG. 1 will be described. As illustrated in FIG. 30, the information processing system 100 includes terminal devices 10A and 10B. Any of the terminal devices 10A and 10B is simply referred to as a “terminal device 10”. Any user uses the terminal device 10A, and any user uses the terminal device 10B. For convenience of description, the terminal device 10A logs in to the conference management server 20, and the terminal device 10B logs in to the image management server 40. The terminal devices 10A and 10B may have functions similar to those in FIG. 3.

The terminal device 10A (an example of a first terminal device) performs the processes described in the first embodiment, and the terminal device 10B (an example of a second terminal device) executes the processes described in the second embodiment. Specifically, the terminal device 10 according to the first embodiment corresponds to the terminal device 10A, and the terminal device 10 according to the second embodiment corresponds to the terminal device 10B. The terminal device 10A performs model update and text information generation, and the terminal device 10B performs model update and text information generation.

As described above, the image management server 40 can selectively use the first tacit knowledge model 4004A or the second tacit knowledge model 4004B, regardless of whether the terminal device 10A logs in to the image management server 40 via the conference management server 20 or the terminal device 10B directly logs in to the image management server 40, in accordance with the login path. In addition, even when the terminal devices 10A and 10B log in to the image management server 40 in parallel (at the same time), the image management server 40 can selectively use the first tacit knowledge model 4004A or the second tacit knowledge model 4004B.

### Fourth Embodiment

A fourth embodiment of the present disclosure describes the image management server 40 that generates an image from a captured image and text information.

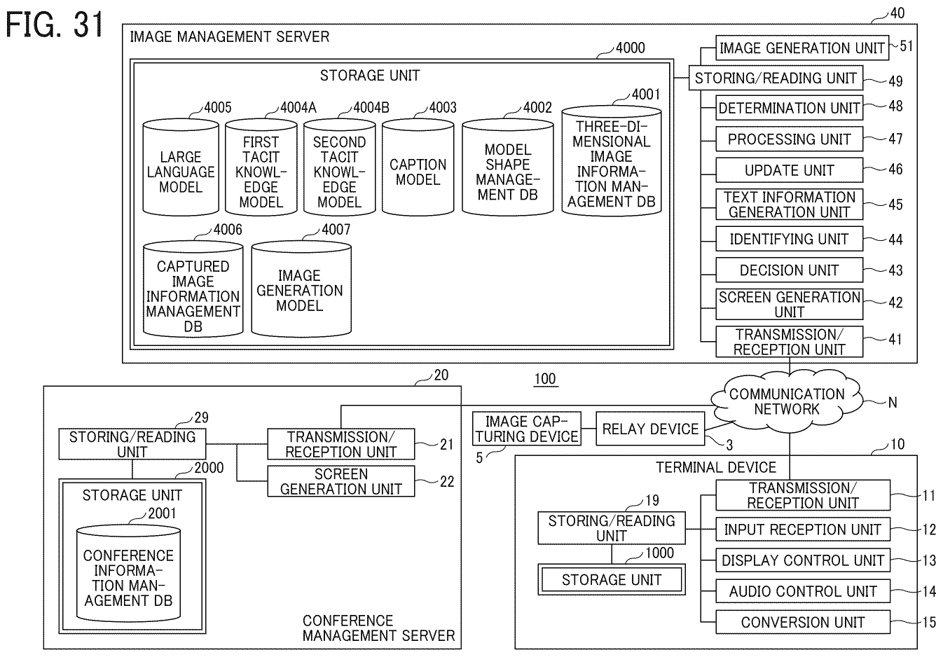

FIG. 31 is a diagram illustrating a functional configuration of an example of functions of the image management server 40, the conference management server 20, and the terminal device 10 in the information processing system 100 according to the present embodiment. In the description of FIG. 31, differences from FIG. 3 will be described.

The image management server 40 illustrated in FIG. 31 further includes an image generation unit 51, and the storage unit 4000 of the image management server 40 further includes an image generation model 4007. The other elements may be the same as those in FIG. 3.

The image generation unit 51 is an example of image generation means and is implemented by instructions from the CPU 401 illustrated in FIG. 2. The image generation unit 51 inputs text data to the image generation model 4007 or inputs text data and an image to the image generation model 4007 to generate image information.

The image generation model 4007 is a machine learning model (generative AI) that generates an image from text data or from text data and an image. The image generation model 4007 is trained using, for example, training data including text data and images. The training data includes, for example, text data or text data and an image for learning as input, and an image as ground truth for output. For example, the image generation model 4007 may be trained such that an image generated by the image generation model 4007 that has received text data or text data and an image included in training data as input becomes close to an image as ground truth included in the training data.

### Learning Phase

The processing in the learning phase may be similar to that illustrated in FIG. 10. In step S20, the update unit 46 updates the first tacit knowledge model 4004A so as to train the first tacit knowledge model 4004A to learn a correspondence between inputs representing a comment determined to have a low level of relevance in step S19 and the past text and an output representing the past capture-generated image or the three-dimensional image information of the article. Alternatively, the update unit 46 updates the first tacit knowledge model 4004A so as to train the first tacit knowledge model 4004A to learn a correspondence between inputs representing the comment, the past text, and the three-dimensional image information (or the captured image) of the article and an output representing the past capture-generated image (or the three-dimensional image information).

### Inference Phase (Text Information Generation)

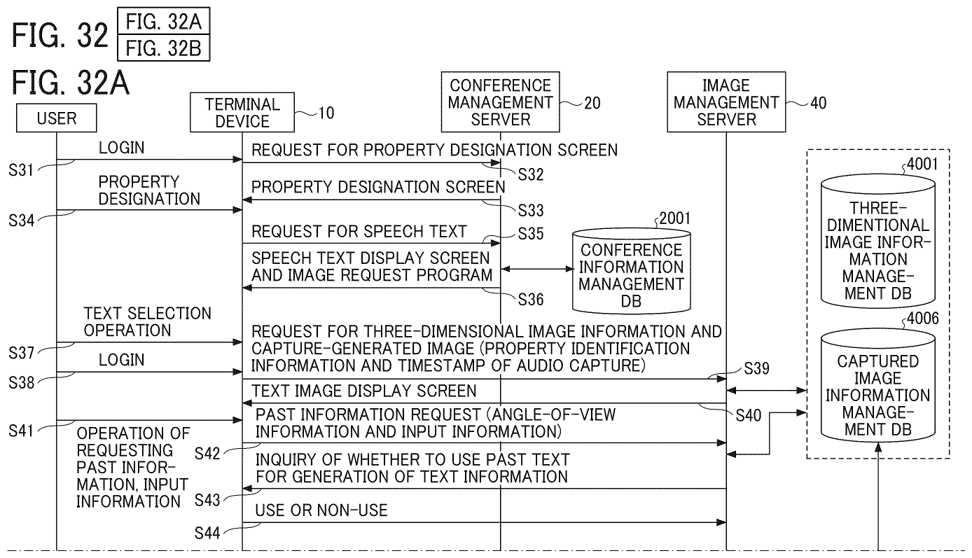

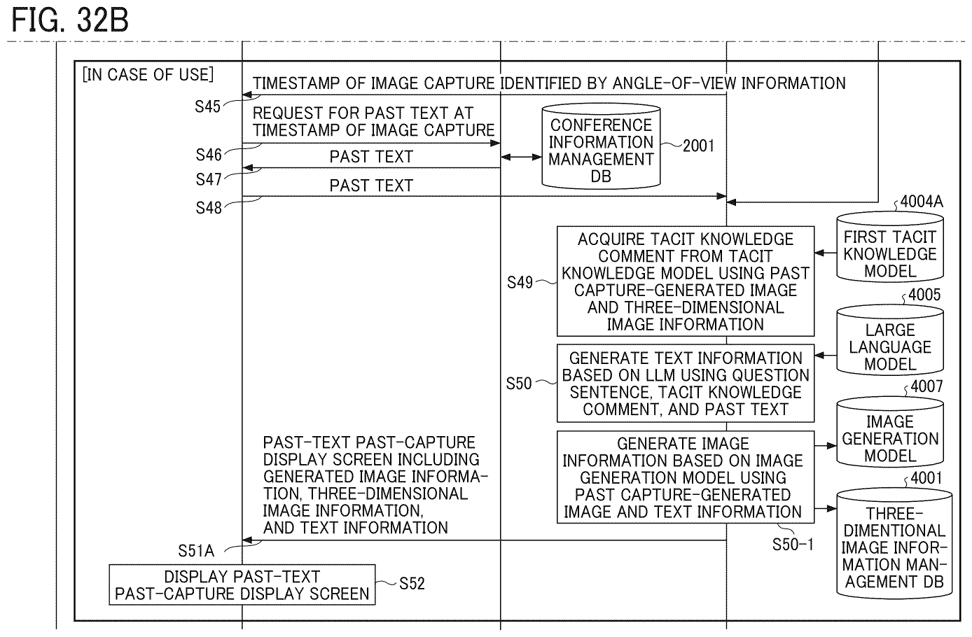

FIG. 32 is a sequence diagram illustrating an example of a process of generating text information and image information. In the description of FIG. 32, differences from FIG. 16 may be described. In FIG. 32, step S50-1 is further included.

S50-1: The image generation unit 51 inputs the past capture-generated image and the text information created by the large language model 4005 to the image generation model 4007 to generate image information. The image generation unit 51 may use the text information created by the large language model 4005, without using the past capture-generated image, to acquire the image information created by the image generation model 4007.

The storing/reading unit 49 stores the text information created by the large language model 4005 and the image information created by the image generation model 4007 in the three-dimensional image information management DB 4001 (or overwrites the information stored in the three-dimensional image information management DB 4001 with the text information created by the large language model 4005 and the image information created by the image generation model 4007) in association with the past text stored in the three-dimensional image information management DB 4001 in step S48.

S51A: The processing unit 47 requests the screen generation unit 42 to generate a screen displaying the three-dimensional image information of the article corresponding to the model ID (received in step S42), the generated image information, and the text information in association with one another. The screen generation unit 42 generates a screen corresponding to the second display area 215 for displaying the three-dimensional image information of the article, the generated image information, and the text information. The transmission/reception unit 41 of the image management server 40 transmits screen information of the screen corresponding to the second display area 215 to the terminal device 10. The transmission/reception unit 11 of the terminal device 10 receives the screen information of the screen corresponding to the second display area 215 transmitted from the image management server 40.

### Example Screen in Inference Phase

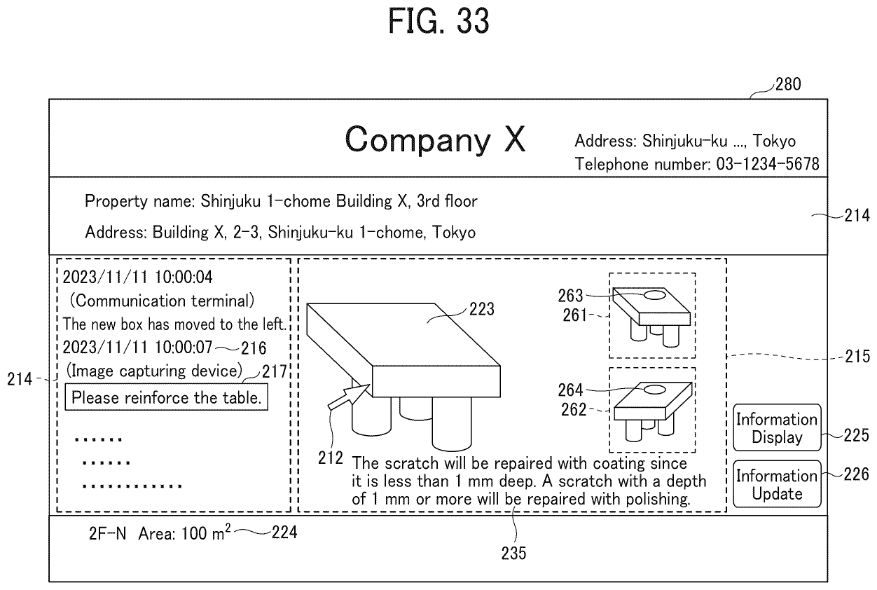

FIG. 33 is a diagram illustrating an example of generated image information displayed on a past-text past-capture display screen 280. In the description of FIG. 33, differences from FIG. 19 will be described.

The past-text past-capture display screen 280 illustrated in FIG. 33 displays generated images 261 and 262. The generated images 261 and 262 are not identical to the capture-generated image 237 and the past capture-generated image 238 illustrated in FIG. 19, but are generated by the image generation model 4007 based on the past capture-generated image 238 and the text information 235. Thus, the generated images 261 and 262 include markers 263 and 264 indicating the positions of a scratch, respectively. One of the generated images 261 and 262 may be the past capture-generated image 238, or the generated images 261 and 262 may be displayed in a switchable manner in response to a user operation.

As described above, the image management server 40 can generate image information using a past capture-generated image and text information, based on the image generation model 4007.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. The image management server 40 described in the embodiments described above is an example, and various example system configurations are applicable depending on the application or the purpose.

For example, the embodiments described above illustrate an example in which a tacit knowledge model for an industry such as civil engineering or architecture answers a question. However, the tacit knowledge model may be used in any industry in which tacit knowledge is effective, such as medical care, dental care, or investment decision-making.

In the embodiments described above, furthermore, the large language model 4005 generates text information based on a tacit knowledge comment. In another example, the large language model 4005 is not used, and a tacit knowledge comment may be used as text information.

The first tacit knowledge model 4004A may be trained on tacit knowledge comments using three-dimensional image information, past capture-generated images, and past text as input and input information as output. That is, different forms of information, such as images and text, may be used as input.

The image management server 40 may generate two items of text information using both the first tacit knowledge model 4004A and the second tacit knowledge model 4004B, rather than either of them. That is, the image management server 40 generates text information using at least one of the first tacit knowledge model 4004A and the second tacit knowledge model 4004B.

In the embodiments described above, furthermore, the information processing system 100 is a client-server system. However, the functions of the image management server 40 may be installed in the terminal device 10 as an application. That is, the user may be allowed to use the functions illustrated in the embodiments described above in a stand-alone manner.

In the example configurations such as the example configuration illustrated in FIG. 3, each configuration is divided according to main functions to facilitate understanding of processing performed by the image management server 40. No limitation on the present disclosure is intended by how the functions are divided by process or by the name of the functions. The processing of the image management server 40 may be divided into more processing units in accordance with the content of the processing. In addition, the division may be performed so that one processing unit contains more processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in one or more embodiments are just one example of plural computing environments that implement the one or more embodiments disclosed herein. In some embodiments, the image management server 40 includes multiple computing devices, such as a server cluster. The multiple computing devices communicate with one another through any type of communication link including a network, shared memory, or the like and perform the processes disclosed herein.

Further, the image management server 40 may perform the processing steps disclosed herein in various combinations. The components of the image management server 40 may be integrated into one apparatus or divided into a plurality of apparatuses. The processes performed by the image management server 40 may be performed by the terminal device 10.

The present disclosure includes the following aspects.

In Aspect 1, an information processing system includes an image management server and a terminal device communicable with the image management server. The image management server manages three-dimensional image information of a target object and a captured image aligned in position with the three-dimensional image information. The image management server includes a first model, a second model, and a text information generation unit. The first model is trained on a correspondence between three-dimensional image information of the target object and speech text based on audio data obtained in response to the captured image being obtained by an image capturing device, or a correspondence among the three-dimensional image information of the target object, the speech text, and input information input to the terminal device. The second model is trained on a correspondence between the three-dimensional image information of the target object and the input information input to the terminal device. The text information generation unit generates text information related to the target object using the three-dimensional image information of the target object for which selection is accepted by the terminal device, the speech text, and the first model, or generates text information related to the target object using the three-dimensional image information of the target object for which selection is accepted by the terminal device and the second model. The terminal device includes a display control unit. The display control unit displays a display screen including the text information.

According to Aspect 2, in the information processing system of Aspect 1, the text information generation unit generates the text information based on the three-dimensional image information of the target object for which selection is accepted by the terminal device, the speech text, input information received by an input reception unit of the terminal device, and the first model, or generates the text information based on the three-dimensional image information of the target object for which selection is accepted by the terminal device, the input information received by the input reception unit of the terminal device, and the second model.

According to Aspect 3, the information processing system of Aspect 1 further includes a text management server that manages the speech text, the text management server is communicable with the terminal device and the image management server. The text information generation unit generates the text information based on the three-dimensional image information of the target object, the speech text transmitted from the text management server, and the first model.

According to Aspect 4, in the information processing system of any one of Aspects 1 to 3, the image management server further includes a determination unit. The determination unit determines whether to generate text information related to the target object using the three-dimensional image information of the target object for which selection is accepted by the terminal device, the speech text, and the first model, or to generate text information related to the target object using the three-dimensional image information of the target object for which selection is accepted by the terminal device and the second model.

According to Aspect 5, in the information processing system of Aspect 4, the determination unit makes a determination of whether to use the first model or to use the second model, based on a selection of whether to use the speech text received by the terminal device or based on input information input via voice or text and received by an input reception unit of the terminal device.

According to Aspect 6, in the information processing system of any one of Aspects 1 to 5, the image management server further includes an update unit. The update unit updates the first model by training the first model to learn a correspondence between the three-dimensional image information of the target object and the speech text, or updates the second model by training the second model to learn a correspondence between the three-dimensional image information of the target object and the input information input to the terminal device without using the speech text.

According to Aspect 7, in the information processing system of Aspect 4 or Aspect 5, the determination unit determines whether to update the first model by training the first model to learn a correspondence between the three-dimensional image information of the target object and the speech text, or to update the second model by training the second model to learn a correspondence between the three-dimensional image information of the target object and the input information input to the terminal device without using the speech text.

According to Aspect 8, in the information processing system of Aspect 3, the display control unit displays the input information on a first display screen that includes the speech text acquired from the text management server and the three-dimensional image information of the target object acquired from the image management server, or displays the input information on a second display screen that does not include the speech text and includes the three-dimensional image information of the target object acquired from the image management server, and the text information generation unit generates the text information based on the input information displayed on the first display screen, the three-dimensional image information of the target object, the speech text, and the first model, or generates the text information based on the input information displayed on the second display screen, the three-dimensional image information of the target object, and the second model.

According to Aspect 9, in the information processing system of Aspect 8, the text information generation unit generates the text information based on the input information displayed on the first display screen, the three-dimensional image information of the target object, the speech text, and the first model, or generates the text information based on the input information displayed on the first display screen, the three-dimensional image information of the target object, and the second model.

According to Aspect 10, the information processing system of Aspect 8 or Aspect 9 further includes an update unit. The update unit updates the first model by training the first model to learn a correspondence among the three-dimensional image information of the target object, the input information, and the speech text, which are displayed on the first display screen, or updates the second model by training the second model to learn a correspondence between the three-dimensional image information of the target object and the input information, which are displayed on the second display screen.

According to Aspect 11, in the information processing system of Aspect 10, the update unit updates the first model by training the first model to learn a correspondence among the three-dimensional image information of the target object, the input information, and the speech text, which are displayed on the first display screen, or updates the second model by training the second model to learn a correspondence between the three-dimensional image information of the target object and the input information, which are displayed on the first display screen.

According to Aspect 12, in the information processing system of Aspect 3, the terminal device communicably connectable to the image management server includes a first terminal device and a second terminal device, the display control unit of the first terminal device displays a first display screen that includes the three-dimensional image information of the target object acquired from the image management server, and the speech text acquired from the text management server, the display control unit of the second terminal device displays a second display screen that includes the three-dimensional image information of the target object acquired from the image management server, and the text information generation unit generates text information related to the target object using the three-dimensional image information of the target object for which selection is accepted by the first terminal device, the speech text, and the first model, and generates text information related to the target object using the three-dimensional image information of the target object for which selection is accepted by the second terminal device and the second model.

According to Aspect 13, in the information processing system of any one of Aspects 1 to 12, the three-dimensional image information of the target object includes a two-dimensional projected representation of a three-dimensional model shape of the target object, and is displayable with varying points of view.

According to Aspect 14, in the information processing system of Aspect 3, the text management server further manages speech text, and the text information generation unit generates the text information based on the three-dimensional image information of the target object, the speech text transmitted from the text management server, and the first model.

1. An information processing system comprising:
an image management server that manages three-dimensional image information of a target object and a captured image aligned in position with the three-dimensional image information, the image management server including server cirucuitry configured to generate text information related to the target object using a first model or a second model; and
a terminal device communicably connected to the image management server, including terminal circuitry configured to display, on a display, a screen including the text information,
the first model being trained on a correspondence between the three-dimensional image information of the target object and speech text based on audio data obtained with the captured image of an image capturing device, or a correspondence between the three-dimensional image information of the target object, the speech text, and input information input to the terminal device,
the second model being trained on a correspondence between the three-dimensional image information of the target object and the input information input to the terminal device,
wherein, when the first model is used, the server circuitry is configured to generate the text information related to the target object using selected three-dimensional image information of the target object having been selected by the terminal device, the speech text, and the first model, and
wherein, when the second model is used, the server circuitry is configured to generate the text information using the selected three-dimensional image information, and the second model.

2. The information processing system according to claim 1, wherein
the server circuitry is configured to:
determine whether to generate the text information using the selected three-dimensional image information of the target object, the speech text, and the first model, or to generate the text information using the selected three-dimensional image information of the target object and the second model; and
generate the text information based on a result of the determination.

3. The information processing system according to claim 1, wherein
the server circuitry is configured to generate the text information further based on input information received by the terminal device.

4. The information processing system according to claim 1, further comprising
a text management server that manages the speech text, the text management server being communicably connected to the terminal device and the image management server, wherein
the server circuitry is configured to receive the speech text from the text management server.

5. The information processing system according to claim 2, wherein
the input information includes audio or characters received by the terminal device, and
the server circuitry is configured to determine whether to use the first model or to use the second model, based on a selection of whether to use the speech text or based on the input information.

6. The information processing system according to claim 2, wherein
the server circuitry is configured to determine whether to update the first model by training the first model to learn a correspondence between the three-dimensional image information of the target object and the speech text, or to update the second model by training the second model to learn the correspondence between the three-dimensional image information of the target object and the input information.

7. The information processing system according to claim 6, wherein
the server circuitry is configured to:
based on a determination that the first model is to be updated,
train the first model to learn the correspondence between the three-dimensional image information of the target object and the speech text to update the first model; and
based on a determination that the second model is to be updated,
train the second model to learn the correspondence between the three-dimensional image information of the target object and the input information to update the second model.

8. The information processing system according to claim 4, wherein the terminal circuitry is configured to:
acquire the speech text from the text management server;
acquire the three-dimensional image information of the target object from the image management server; and
display the input information on a first screen, the first screen including the speech text and the three-dimensional image information of the target object, and
the server circuitry is configured to generate the text information based on the input information, the selected three-dimensional image information, the speech text, and the first model.

9. The information processing system according to claim 4, wherein the terminal circuitry is configured to:
acquire the three-dimensional image information of the target object from the image management server; and
display the input information on a second screen, the second screen including the three-dimensional image information of the target object, and
the server circuitry is configured to generate the text information based on the input information, the selected three-dimensional image information, and the second model.

10. The information processing system according to claim 8, wherein
the server circuitry is configured to update the first model by training the first model to learn the correspondence between the three-dimensional image information of the target object, the input information, and the speech text, each being displayed on the first screen.

11. The information processing system according to claim 9, wherein
the server circuitry is configured to update the second model by training the second model to learn the correspondence between the three-dimensional image information of the target object and the input information, each being displayed on the first screen.

12. The information processing system according to claim 4, wherein
the terminal device includes a first terminal device and a second terminal device,
the terminal circuitry includes first terminal circuitry that resides on the first terminal device, and second terminal circuitry that resides on the second terminal device,
the first terminal circuitry is configured to display a first screen, the first screen including the three-dimensional image information of the target object acquired from the image management server, and the speech text acquired from the text management server,
the second terminal circuitry is configured to display a second screen, the second screen including the three-dimensional image information of the target object acquired from the image management server, and
the server circuitry is configured to:
generate the text information using the selected three-dimensional image information of the target object having been selected by the first terminal device, the speech text, and the first model,
generate the text information using the selected three-dimensional image information of the target object having been selected by the second terminal device and the second model.

13. The information processing system according to claim 1, wherein
the three-dimensional image information of the target object includes a two-dimensional projected representation of a three-dimensional model shape of the target object, and
the terminal circuitry is configured to display the three-dimensional image information of the target object in accordance with a change in point of view.

14. The information processing system according to claim 4, wherein
the server circuitry is configured to generate the text information based on the selected three-dimensional image information, the speech text transmitted from the text management server, and the first model.

15. An image management server communicably connected to a terminal device, the image management server comprising:
server circuitry configured to
generate text information related to a target object using a first model or a second model, and transmit a screen including the text information to the terminal device to display the screen on the terminal device,
the first model being trained on a correspondence between three-dimensional image information of the target object and speech text based on audio data obtained with a captured image of an image capturing device, the captured image to be aligned in position with the three-dimensional image information, or a correspondence between the three-dimensional image information of the target object, the speech text, and input information input to the terminal device;
the second model being trained on a correspondence between the three-dimensional image information of the target object and the input information input to the terminal device,
wherein, when the first model is used, the server circuitry is configured to generate the text information related to the target object using selected three-dimensional image information of the target object having been selected by the terminal device, the speech text, and the first model, and
wherein, when the second model is used, the server circuitry is configured to generate the text information using the selected three-dimensional image information, and the second model.

16. A non-transitory recording medium storing a plurality of instructions which, when executed by one or more processors, causes the one or more processors to perform a method comprising:
generating text information related to a target object using a first model or a second model; and
displaying, on a display, a screen including the text information,
the first model being trained on a correspondence between three-dimensional image information of the target object and speech text based on audio data obtained with a captured image of an image capturing device, the captured image to be aligned in position with the three-dimensional image information, or a correspondence between the three-dimensional image information of the target object, the speech text, and input information input to a terminal device;
the second model being trained on a correspondence between the three-dimensional image information of the target object and the input information input to the terminal device,
wherein, when the first model is used, the generating includes generating the text information related to the target object using selected three-dimensional image information of the target object having been selected by the terminal device, the speech text, and the first model, and
wherein, when the second model is used, the generating includes generating the text information using the selected three-dimensional image information, and the second model.
